(19) United States
(12) Patent Application Publication
(10) Pub. No.: US 2025/0086397 A1
(43) Pub. Date: Mar. 13, 2025

(54) SYSTEMS AND METHODS FOR AI-ASSISTED FEATURE ENGINEERING

(71) Applicant: FeatureByte, Inc., Shrewsbury, MA (US)

(72) Inventors: Xavier S. Conort, Singapore (SG); Hon Nian Chua, Singapore (SG); Sergey Yurgenson, Marlborough, MA (US)

(73) Assignee: FeatureByte, Inc., Shrewsbury, MA (US)

(21) Appl. No.: 18/883,905

(22) Filed: Sep. 12, 2024

Related U.S. Application Data
(60) Provisional application No. 63/582,104, filed on Sep. 12, 2023.

(51) Int. Cl. G06F 40/30; G06F 16/2455

(52) U.S. Cl. CPC G06F 40/30; G06F 16/2456

(57) ABSTRACT

A method for feature selection includes (i) obtaining a description of a use case for a machine learning model and metadata relating to a set of source data for the machine learning model, (ii) producing, using a feature engineering model, one or more views of the set of source data for the machine learning model, (iii) creating a plurality of candidate features based at least in part on the one or more views, (iv) assessing relevance of the plurality of candidate features to the use case by a semantic relevance model, and (v) adding one or more features selected from the plurality of candidate features to a feature set for the use case for the machine learning model based on the relevance of the one or more candidate features to the use case as assessed by the semantic relevance model.

### CROSS REFERENCE TO RELATED APPLICATION(S)

This application claims priority and benefit under 35 U.S.C. § 119 (e) of U.S. Provisional Patent Application No. 63/582,104, filed Sep. 12, 2023, the entire contents of which are hereby incorporated by reference herein.

### FIELD OF TECHNOLOGY

The present disclosure relates generally to feature engineering and, more specifically, to AI-assisted systems and methods for feature engineering.

### BACKGROUND

Artificial intelligence models and related systems may be configured to generate output data (e.g., predictions, inferences, and/or content) based on input data aggregated from a number of data sources (e.g., source tables). Training and using an artificial intelligence model (e.g., a machine-learning model) to generate output data based on input data can involve a number of steps. Data sources (e.g., raw data) can be identified and processed to create source data (e.g., tables), which can indicate the attributes of various entities (e.g., at various times). The source data may contain features of interest, and/or such features may be generated by performing one or more data transformations on the source data. The processes of generating and/or identifying such features may be referred to as “feature engineering” and/or “feature selection.” During a model training process, sets of features can be used to train a model to provide the desired output data. After the model has been trained, similar sets of features can be provided as input to the model, which can then generate the corresponding output data.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In some aspects, the techniques described herein relate to a method including: obtaining a description of a use case for a machine learning model and metadata relating to a set of source data for the machine learning model; producing, using a feature engineering model, one or more views of the set of source data for the machine learning model based at least in part on the description of the use case and the metadata; creating a plurality of candidate features based at least in part on the one or more views; assessing relevance of the plurality of candidate features to the use case, wherein assessing the relevance of the plurality of candidate features includes assessing, by a semantic relevance model, semantic relevance of the plurality of candidate features to the use case; and adding one or more features selected from the plurality of candidate features to a feature set for the use case for the machine learning model based on the relevance of the one or more candidate features to the use case as assessed by the semantic relevance model.

In some aspects, the techniques described herein relate to an apparatus including: at least one processor; and at least one computer-readable storage medium having encoded thereon executable instructions that, when executed by the at least one processor, cause the at least one processor to perform operations including: obtaining a description of a use case for a machine learning model and metadata relating to a set of source data for the machine learning model; producing, using a feature engineering model, one or more views of the set of source data for the machine learning model based at least in part on the description of the use case and the metadata; creating a plurality of candidate features based at least in part on the one or more views; assessing relevance of the plurality of candidate features to the use case, wherein assessing the relevance of the plurality of candidate features includes assessing, by a semantic relevance model, semantic relevance of the plurality of candidate features to the use case; and adding one or more features selected from the plurality of candidate features to a feature set for the use case for the machine learning model based on the relevance of the one or more candidate features to the use case as assessed by the semantic relevance model.

In some aspects, the techniques described herein relate to a non-transitory computer-readable medium including one or more computer-readable instructions that, when executed by at least one processor of a computing device, cause the computing device to: obtain a description of a use case for a machine learning model and metadata relating to a set of source data for the machine learning model; produce, using a feature engineering model, one or more views of the set of source data for the machine learning model based at least in part on the description of the use case and the metadata; create a plurality of candidate features based at least in part on the one or more views; assess relevance of the plurality of candidate features to the use case, wherein assessing the relevance of the plurality of candidate features includes assessing, by a semantic relevance model, semantic relevance of the plurality of candidate features to the use case; and add one or more features selected from the plurality of candidate features to a feature set for the use case for the machine learning model based on the relevance of the one or more candidate features to the use case as assessed by the semantic relevance model.

The foregoing Summary is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of an exemplary feature engineering control platform, in accordance with some embodiments.

FIG. 2 is a flow diagram of an example method for feature engineering, in accordance with some embodiments.

FIG. 3 is a block diagram of an example feature engineering system, in accordance with some embodiments.

FIG. 4 is a flow diagram of another example method for feature engineering, in accordance with some embodiments.

FIG. 5 is a block diagram of an example computer system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Systems and methods for feature engineering (e.g., AI-assisted feature engineering) are described herein. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

### Terms

The term “generative model” as used herein may generally refer to a type of machine learning model that is trained on existing data to enable the generative model to generate, based on an input or prompt, new data that shares characteristics similar to that of the training data. In some examples, a generative model may handle text. In these examples, the generative model may accept text prompts and produce text outputs. Any suitable type of AI model can be used, including predictive models, generative models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a dataset), diagnostic analytics (e.g., processes for inferring why specific trends, patterns, anomalies, etc. are present in a dataset), predictive analytics (e.g., processes for predicting future events or outcomes), and prescriptive analytics (processes for determining or suggesting a course of action). “Machine learning” may refer to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference dataset.

In certain examples, “source data” can refer to data received from data sources (e.g., source tables) connected to a data warehouse of the feature engineering control platform. In some cases, source data may include tabular data (e.g., one or more tables) including one or more rows and one or more columns. Users may identify (e.g., annotate and/or tag) columns of a table to define key(s) for the table during registration of data sources (e.g., source tables). In some cases, source data may include one or more records (e.g., one or more rows of a table), where each record or set of records includes and/or is otherwise associated with a timestamp. A record included in the source data (e.g., a table) may be immutable. When information included in records of source data (e.g., a table) changes, the changes may be tracked in a corresponding slowly changing dimension table. If records of the source data (e.g., table) are overwritten without keeping historical records, the source data may not be a suitable candidate for feature engineering based on the changes potentially causing (1) severe data leaks during training of an artificial intelligence model; and/or (2) poor performance of inferences generated by an artificial intelligence model.

Source data can include, for example, time-series data, event data, sensor data, item data, slowly changing dimension data, dimension data, etc. In certain examples, “time-series data” (e.g., “time-series table”) can refer to data (e.g., tabular data) collected at successive, regularly spaced (e.g., equally spaced) points in time. In some cases, rows in a time-series data table may represent an aggregated measure over the time unit (e.g., daily sales) and/or balances at the end of a time period. In some cases, records may be missing from a time-series data table and the time unit (e.g., hour, day, month, year) of the time-series data table may be assumed to be constant over time. Other data associated with timestamps and collected at irregularly spaced points in time may be referred to as “sensor data” (e.g., “sensor table”) or “event data” (e.g., “event table”). A row in a sensor table may be representative of a measurement that occurs at predictable intervals. A row in an event table may be representative of a discrete event (e.g., business event) measured at a point-in-time.

In certain examples, a “view” and/or “view object” can refer to a data object derived from source data (e.g., a table) based on applying at least one data transformation to the source data. Examples of views can include an event view derived from an event table, an item view derived from an item table, a time-series view derived from a time-series table, a slowly changing dimension view derived from a slowly changing dimension table, a dimension view derived from a dimension table, etc.

In certain examples, “primary table” of a feature can refer to the table associated with a view from which the feature has been derived. When the view is enriched by the joins of other table views, the other source data may be referred to as the “secondary table” of the feature.

In certain examples, an “entity” can refer to a thing (e.g., a physical, virtual, or logical thing) that is uniquely identifiable (e.g., has a unique identity), or to a class of such things. In some examples, an entity may be used to define, serve, and/or organize features. For example, an entity may be used to define a use case of an artificial intelligence model. An “entity type” can refer to a class of entities that share a particular set of attributes. Some non-limiting examples of physical entity types can include customer, house, and car. Some non-limiting examples of logical or virtual entity types can include merchant, account, credit card, and event (e.g., transaction or order). An “entity instance” can refer to an individual occurrence of an entity type. As used herein, the term “entity” can refer to an entity type and/or to an entity instance, consistent with the context in which the term is used. In some examples, an entity (e.g., an entity type or an entity instance) may be associated with or correspond to a set of source data (e.g., a table, a row of a table (“record”), or a column of a table (“field”)).

One non-limiting example of an entity type is an “event entity,” which represents an event. In some examples, event entities include data indicating a time associated with the event (e.g., a timestamp indicating when the event occurred) or a duration of the event (e.g., a start timestamp indicating a time when the event started and an end timestamp indicating a time when the event ended). For example, an event entity representing a purchase transaction may have a single timestamp indicating when the transaction occurred, while an entity representing a browsing session may have start and end timestamps indicating when the browsing session started and ended. The difference between the end timestamp and the start timestamp of an event entity may indicate a duration of the event. Event entities are described in greater detail below.

In certain examples, an “entity relationship” can refer to a relationship that exists between two entities. A “child-parent relationship” can be established when the instances of the child entity are uniquely associated with the parent entity instance. For example, for an organization, the Employee entity can be a child of the Department entity. A “subtype-supertype relationship” can be established when the instances of the subtype entity are a subset of the instances of the supertype entity. For example, the Employee entity can be a subtype of the Person entity and the Customer entity can be a subtype of the Person entity.

In certain examples, a “feature” can refer to an attribute of an entity derived from source data (e.g., a table). A feature can be then provided as an input to an artificial intelligence model associated with this entity for training and production operation of the artificial intelligence model. Features may be generated based on view(s), and/or other feature(s) as described herein. In some cases, features may use attributes available in views. For example, a customer churn model may use features directly extracted from a customer profile table representing customer's demographic information such as age, gender, income, and location. In some cases, features can be derived from a series of row transformations, joins, and/or aggregates performed on views. For example, a customer churn model may use aggregated features representing a customer's account information such as the count of products purchased, the count of orders canceled, and the amount of money spent. Other examples of features representing a customer's behavioral information can include the number of the customer complaints per type of complaints and the timing of the customer interactions. In some cases, features can be derived using one or more user-defined transformation functions. For example, transformer-based models or large language models (LLMs) can be encapsulated in user-defined transformation functions, which can be used to generate embeddings (e.g., text embeddings).

Features can also have data types. For example, a feature can have a numerical data type, a date-time type, a text data type, a categorical data type, a dictionary data type, or any other suitable data type.

In certain examples, a “feature job” can refer to the materialization of a particular feature and its storage in an online feature store to serve model inferences. A feature job may be scheduled on a periodic basis with a particular frequency, execution timestamp, and blind spot as described herein.

In certain examples, a “feature request” can refer to the serving of a feature. Types of feature requests can include a historical feature request and an online feature request. Historical requests can be made to generate training data to train and/or test models. Online requests can be made to generate inference data to generate output data.

In certain examples, a “point-in-time” can refer to a time when an online feature request is made for model inference.

In certain examples, a “point-in-time” may be used in the context of a historical feature request. For a historical feature request, “point-in-time” can refer to the time of past simulated requests encapsulated in the historical feature request data. A historical feature request data may typically be associated with a large number of “points-in-time”, such that models can learn from a large variety of circumstances.

In certain examples, an “observation set” can refer to request data of a historical feature request. The observation set can provide the entity instances from which the model can learn together with the past points-in-time associated with each entity instance. The sampling of the entity instances and the choice of their points-in-time can be carefully made to avoid biased predictions or overfitting. For example, for a model to predict customer churn in the next 6 months, the points-in-time can cover a period of at least one year to ensure all seasons are represented and the customer instances (e.g., customer identifier values) can be drawn from the population of customers active as at the points-in-time to prevent bias. For the same example, the time interval between two points-in-time for a given customer instance can be larger than 6 months (e.g., the churn horizon) to prevent leaks.

In certain examples, a “context” can refer to circumstances in which feature(s) are expected to be served. A context may include an indication of at least one entity with which the context is related, a context name, and/or a description. In some cases, a context may include an expected inference time or an expected inference time period for the context and a context view that can mathematically define the context. For example, for a model that predicts customer churn, the context entity is customer, the context's description may be active customer, and the context's expected inference time may be every Monday between 2 am and 3 am. A context view for the context may be a table of the customer instances together with their periods of activity.

In certain examples, a “use case” can refer to a modeling problem to be solved. The modeling problem of a use case may be solved by an artificial intelligence model, such as a machine-learning model. A use case may be associated with a context and a target for which the artificial intelligence model learns to generate output data (e.g., predictions). In some cases, the target may be defined based on a target recipe that can be served together with features during historical feature requests. For example, for a model that predicts customer churn, the target recipe may retrieve a Boolean value that indicates the customer churn within 6 months after the points-in-time of the historical feature request. The target recipe can be used to track the accuracy of predictions generated by the artificial intelligence model in production.

As used herein, “data analytics model” may refer to any suitable model artifact generated by the process of using a machine learning algorithm to fit a model to a specific training dataset. The terms “data analytics model,” “machine learning model” and “machine learned model” are used interchangeably herein.

As used herein, the “development” of a machine learning model may refer to construction of the machine learning model. Machine learning models may be constructed by computers using training datasets. Thus, “development” of a machine learning model may include the training of the machine learning model using a training dataset. In some cases (generally referred to as “supervised learning”), a training dataset used to train a machine learning model can include known outcomes (e.g., labels or target values) for individual data samples in the training dataset. For example, when training a supervised computer vision model to detect images of cats, a target value for a data sample in the training dataset may indicate whether or not the data sample includes an image of a cat. In other cases (generally referred to as “unsupervised learning”), a training dataset does not include known outcomes for individual data samples in the training dataset.

Following development, a machine learning model may be used to generate inferences with respect to “inference” datasets. As used herein, the “deployment” of a machine learning model may refer to the use of a developed machine learning model to generate inferences about data other than the training data.

### Generative Al and Deep Learning (DL)

Recently, generative artificial intelligence (“generative Al” or “Gen AI”) applications have been developed. Generative AI technology has the ability to generate new and original content, including text, imagery, audio, source code, synthetic data, etc. Generative AI, driven by AI algorithms and advanced neural networks, empowers machines to go beyond traditional rule-based programming and engage in autonomous, creative decision-making. By leveraging large datasets and the power of machine learning, generative AI algorithms can generate new content, simulate human-like behavior, and even compose music, write code, and create visual art. This technology is quickly impacting diverse industries and sectors, from healthcare and finance to manufacturing and entertainment. For example, generative AI has shown promising results in information retrieval, question answering, computer vision, natural language processing, content generation (text, images, video, software code, music, audio, etc.), software development, healthcare (e.g., predicting protein structures, identifying drug candidates), motion control and navigation (e.g., for autonomous robots), and other domains.

Generative AI technology generally utilizes generative models such as Generative Adversarial Networks (GANs), transformer-based models, diffusion models (e.g., stable diffusion models), and/or Variational Autoencoders (VAEs), etc., which are based on artificial neural networks and deep learning. Deep Learning (DL) is a subset of machine learning (ML) that focuses on artificial neural networks (ANN) and their ability to learn and make decisions. Deep Learning involves the use of complex algorithms to train ANNs to recognize patterns and make predictions based on large amounts of data. A key difference between DL and traditional ML algorithms is that DL algorithms can learn multiple layers of representations, allowing them to model highly nonlinear relationships in the data. This makes them particularly effective for applications such as image and speech recognition, natural language processing (NPL), etc.

Most DL methods use ANN architectures, which is why DL models are often referred to as deep neural networks (DNNs). The term “deep” refers to the number of hidden layers in the neural network. For example, a traditional ANN may only contain 2-3 hidden layers, while DNNs can have as many as 150 layers (or more). DL uses these multiple layers to progressively extract higher-level features from the raw input. For example, in image processing, lower layers may identify edges, while higher layers may identify the concepts relevant to a human, such as digits or letters or faces. DL models are trained by using large sets of labeled data and ANN architectures that learn features directly from the data without the need for manual feature extraction.

### Large Language Models (LLM) and Transformer Networks

In many generative Al systems, the generative model that generates content is a large language model (LLM). A large language model (LLM) is a type of ML model that can perform a variety of natural language processing (NLP) tasks such as generating and classifying text, answering questions in a conversational manner, and translating text from one language to another. The term ‘large’ refers to the number of values (parameters) the language model can change autonomously as it learns. Some LLMs have hundreds of billions of parameters. In general, LLMs are neural network (NN) models that have been trained using deep learning techniques to recognize, summarize, translate, predict, and generate content using very large datasets.

Many state-of-the-art LLMs use a class of deep learning architectures called transformer neural networks (“transformer networks” or “transformers”). A transformer is a neural network that learns context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models.

Two key innovations that make transformers particularly adept for large language models are positional encodings and self-attention. Positional encoding embeds the order in which the input occurs within a given sequence. Rather than feeding words within a sentence sequentially into the neural network, with positional encoding, the words can be fed in non-sequentially. Self-attention assigns a weight to each part of the input data while processing it. This weight signifies the importance of that portion of the input in the context of the rest of the input. The use of the attention mechanism enables models to focus on the parts of the input that matter the most. This representation of the relative importance of different inputs to the neural network is learned over time as the model sifts and analyzes data. These two techniques in conjunction allow for analyzing the subtle ways and contexts in which distinct elements influence and relate to each other over long distances, non-sequentially. The ability to process data non-sequentially enables the decomposition of the complex problem into multiple, smaller, simultaneous computations.

“Completion” may refer to the process of a generative model generating additional content (e.g., text) based on a provided prompt (e.g., text), e.g., providing the next word in a sentence. The additional content (e.g., text) provided by the generative model may be referred to herein as a “completion.” Completions generated by generative models may include text, audio data (e.g., speech, music, etc.), image data (e.g., images), video data (e.g., videos), time-series data, or any other suitable type of data. “Prompting” may refer to a technique in which a generative model (e.g., an LLM) is matched to a desired downstream task by formulating the task as natural language text explaining the desired behavior, such that a generative model can carry out the task by performing text completion. Often these instructions are split into a “system message” containing general task instructions providing general guidance about the desired behavior and a “prompt template” containing the portion of the prompt that contains indicator values that are substituted in each use. “Fine-tuning” may refer to the process whereby a generative model is adapted to a particular task by changing its parameters by providing prompts with desired completions.

### Motivation for and Benefits of Some Embodiments

There is a large and growing market for machine learning (ML)/artificial intelligence (AI) models that can generate predictions, inferences, and/or content. Some examples of industries and applications of ML/AI models include the automotive industry (e.g. self-driving cars), healthcare industry (e.g., medical devices, health monitoring software, etc.), manufacturing and supply-chain industries (e.g., industrial automation), robotics, etc. Additionally, the field of marketing significantly benefits from ML/AI, with applications in customer behavior analysis, personalized content creation, predictive analytics for market trends, and automation of digital marketing campaigns. These advancements in ML/AI are revolutionizing how businesses interact with and understand their customers.

However, the process of building high-quality models can be difficult, expensive, and time-consuming. Initially, data sources of interest can be identified or obtained, and features of interest can be generated from the data sources using feature engineering techniques. Although many aspects of data identification and feature engineering are often performed manually, feature pipelines may be used to generate and serve datasets containing engineered features. Such datasets can be used as training data in a model-training process or provided as input data (e.g., “inference data” or “production data”) to a trained model which can generate output data based on the input data.

In the past decade, there have been advances in automated machine learning (“AutoML”) technology, which have made it easier to build models based on a given set of features. However, given the enormous amount of data available, and the almost-endless ways in which data sources can be combined and transformed to generate new features, the ‘solution space’ for feature discovery, engineering, and selection is enormous, and choosing a suitable set of features for a use case largely remains a manual, labor-intensive, intuition-driven process of trial-and-error. Finding the best solutions tends to require a combination of domain knowledge and data science expertise that few individuals possess. Some automated feature engineering techniques have been developed, but many of these techniques tend to generate a large number of features that have little or no relevance to the problems that users are attempting to solve. Thus, there is a need for more efficient, rigorous, data-driven systems and methods for identifying feature candidates.

Described herein are embodiments of feature engineering systems that use efficient, rigorous, data-driven techniques to identify the best feature candidates in the vast feature solution space for a user-specified use case. In some examples, such feature engineering systems can automatically suggest features (e.g., existing features from a feature catalog and/or new features that can be generated from available data sources) suitable for a specified use case. In some examples, feature discovery processes (e.g., automatically selecting one or more features for use in training a model, or recommending one or more features for such use; automatically generating a new feature by performing one or more data transformations on source data and/or existing features, or recommending the generation of such new features, etc.) are guided by characterizations of available data objects (e.g., source data, tables, views, features, etc.), such that better feature candidates (e.g., feature candidates that are individually or collectively more relevant to the use case) in the feature solution space are selected, generated, or recommended by the system, and worse feature candidates (e.g., feature candidates that are individually or collectively less relevant to the use case) are not selected, generated, or recommended. Some examples of suitable characterizations of data objects can include data indicating semantic types assigned to fields of source data, signal types or data types assigned to features, lineage of features, entity types associated with different tables of source data and the relationships among those entities, data types of views of the source data, etc. For example, a feature engineering system can limit the types of data transformation operations automatically applied to or recommended for a set of data objects during a feature discovery process based on the characterizations of the data objects.

Aside from the challenges associated with efficiently identifying high-quality feature candidates, conventional feature engineering techniques generally exhibit several deficiencies. Some non-limiting examples of such difficulties can include (1) accessing correct raw data sources (e.g., source tables) for aggregating raw data; (2) building and generating features from aggregated raw data; (3) combining generated features into training data used to train the artificial intelligence model; (4) materializing and serving features in production when the artificial intelligence model is deployed; and (5) monitoring features in production for irregularities and discrepancies, such as feature drift and missing data sources (e.g., source tables). Accordingly, there is a need for improved techniques for generating and serving features for artificial intelligence models and related systems.

Features extracted from source data and/or from other features can be stored in a feature catalog. In some examples, signal types can be automatically derived and assigned to the features to facilitate aspects of feature engineering. For example, the feature catalog can be searched by signal type to facilitate the efficient identification of high-quality features relevant to a use case, and the identified features can be used to train machine learning models, develop insights into the data, and/or generate additional features.

In some examples, AI-assisted feature engineering techniques can reduce the dimensionality of the feature space for a use case from a large number of candidate features to a much smaller number of suggested or selected features, which are relevant (e.g., semantically and/or statistically relevant) to the use case. Some examples of AI-assisted feature engineering systems and methods are provided. In some examples, these AI-assisted feature engineering techniques are used to identify candidate features relevant to a use case (including candidate features in a feature catalog, candidate features present within source data, and/or candidate features derivable from source data by applying one or more transformations to the source data). Any suitable type of relevance can be identified, including semantic relevance to the use case, statistical relevance to the target variable of the use case (e.g., correlation with the target variable), etc. In some examples, these AI-assisted feature engineering techniques are used to assess the relevance of the candidate features to the use case, and to add a subset of the candidate features to a feature set for the use case. The features added to the feature set can be used to train a machine learning model for the use case.

### Feature Engineering Control Platform Architecture

This section of the disclosure provides a description of improved systems and methods that simplify the generation and serving of features needed for artificial intelligence and machine learning. A feature engineering control platform is described herein that can enable individuals (referred to herein as “users”) responsible for developing and managing artificial intelligence models to transform source data, declare features, and run experiments to analyze and evaluate declared features and train artificial intelligence models. Based on experimentation, the feature engineering control platform can enable deployment of feature sets without generating separate feature pipelines or using alternative tools. Complexity associated with such deployment can be abstracted away from users and features can be automatically materialized into an online and/or offline feature store included in the feature engineering control platform. Features included in the online feature store may be made available for serving to artificial intelligence models and related systems with low latency (e.g., via an application programming interface (API) service such as a representational state transfer (REST) API service).

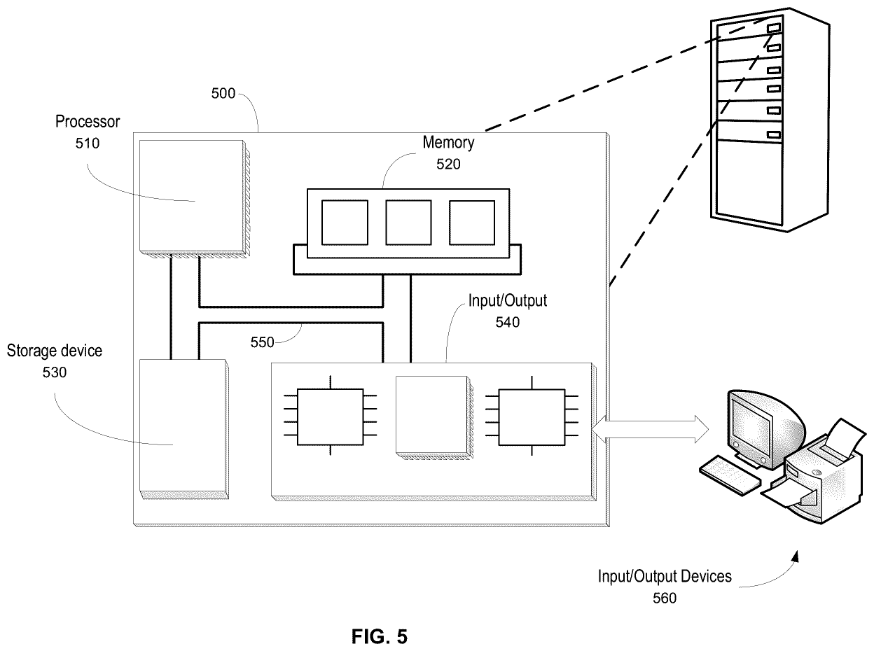

In some embodiments, to remedy several of the deficiencies of existing techniques for feature engineering for artificial intelligence models as described herein, a feature engineering control platform may be introduced. A feature engineering control platform may operate at a computing system including one or more computing devices (e.g., as described with respect to FIG. 5) communicatively connected by one or more computing networks. In some cases, the feature engineering control platform may operate and be stored in a cloud computing system (also referred to as a “cloud data platform”) provided by a cloud computing provider. The cloud computing system may be associated with and/or otherwise store data corresponding to a client. In some cases, the client associated with the cloud computing system may be the cloud computing provider. In some cases, the client associated with the cloud computing platform may be different from a platform provider that provides the feature engineering control platform for use by the client. The feature engineering control platform may integrate with a client's data warehouse stored in the cloud computing platform and may receive metadata associated with source data stored and/or received by the client's data warehouse.

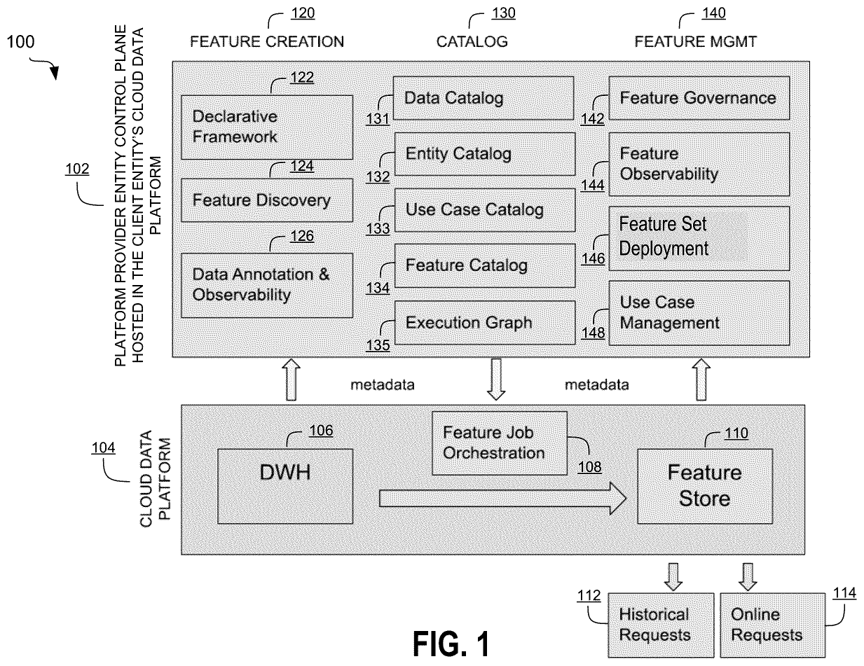

In some embodiments, the feature engineering control platform may be used to automatically and/or manually (e.g., via user input) perform operations for feature creation, feature cataloging, feature management, feature job orchestration, and feature serving relating to training and production operation of artificial intelligence (e.g., machine-learning) models. FIG. 1 is a block diagram of an exemplary feature engineering control platform 100, in accordance with some embodiments as discussed herein. As shown in FIG. 1, feature engineering control platform 100 may operate on one or more computing devices of a cloud data platform 104 (e.g., a cloud data platform corresponding to a client). Feature engineering control platform 100 may also include a platform provider control plane 102 that includes a number of facilities. In some cases, cloud data platform 104 may include one or more facilities corresponding to the platform provider that are external to platform provider control plane 102. In some cases, feature engineering control platform 100 may include a data warehouse 106 for storage and reception of tables from a number of data sources as described below. Data warehouse 106 may be managed and/or otherwise controlled by the client and may be stored in cloud data platform 104.

In some embodiments, the platform provider control plane 102 may include a feature candidate creation facility 120, feature cataloging facility 130, and feature management facility 140. Feature candidate creation facility 120 may include data annotation and observability facility 126, declarative framework facility 122, and/or feature discovery facility 124. Feature cataloging facility 130 may include data catalog facility 131, entity catalog facility 132, use case catalog facility 133, feature catalog facility 134, and execution graph facility 135. Feature management facility 140 may include feature governance facility 142, feature observability facility 144, feature set deployment facility 146, and use case management facility 148. Additional features of the above-described facilities are described herein.

In some embodiments, one or more facilities corresponding to the platform provider that are included in the feature engineering control platform 100 may be external to platform provider control plane 102. Examples of such external facilities can include facilities relating to feature serving such as feature job orchestration facility 108 and feature store facility 110 (e.g., a feature store) stored and operating in a client's data warehouse 106. Additional aspects of the feature job orchestration and feature store facilities are described herein. In some cases, metadata may be exchanged between the facilities included in platform provider control plane 102 and any of the facilities stored in and executing on cloud data platform 104. In some cases, feature store facility 110 may respond to received historical requests 112 and/or online requests 114 for feature data. The historical and/or online requests may be sent by external artificial intelligence models and related computing systems that are communicatively connected to feature engineering control platform 100. Feature store facility 110 may provide feature values in response to historical requests 112 and/or online requests 114 for training of artificial intelligence models and/or for production operation of artificial intelligence models. Production operation of an artificial intelligence model can refer to the artificial intelligence model generating output data (e.g., predictions, inferences, and/or content) based on feature values served to the model.

In some embodiments, feature engineering control platform 100 may include a graphical user interface that is accessed by a client computing device via a network (e.g., internet network). The graphical user interface may be displayed and/or otherwise made available via an output device (e.g., display) of the client computing device. A user may provide inputs to the graphical user interface via input device(s) included in and/or connected to the client computing device. The graphical user interface may enable viewing and interaction with feature data and data associated with the facilities of the feature engineering control platform as described herein.

In some embodiments, the feature engineering control platform may include a software development kit (SDK) that is used by a client computing device to access and interact with the feature engineering control platform via a network (e.g., internet network). Execution of software (e.g., computer-readable code) using the SDK may enable interaction with feature data and data associated with the facilities of the feature engineering control platform as described herein.

### Feature Creation

In some embodiments, facilities of a feature engineering control platform corresponding to feature creation may include data annotation and observability, declarative framework, and/or feature discovery facilities. The data annotation and observability facility of the platform provider control plane may perform functions relating to registration of source data (e.g., source tables), annotation of data types, entity tagging, data semantics tagging, data cleaning, exploratory data analysis, and data monitoring for source data (e.g., tables) registered with the feature engineering control platform and stored in the data warehouse. The data warehouse may ingest and store source data (e.g., tables) of one or more types. Some non-limiting examples of types of source data (e.g., tables) that may be recognized and used by the feature engineering control platform to generate features may include event tables including event data, item tables including item data, slowly changing dimension tables including slowly changing dimension data, dimension tables including dimension data, and time-series tables including time-series data. Additional non-limiting examples of types of source data (e.g., tables) that may be recognized and used by the feature engineering control platform to generate features may include sensor tables and calendar tables. A type of an instance of source data (e.g., table) may determine the transformations that may be applied to the source data (e.g., table) as described herein. In some cases, each of the types of source data used by the feature engineering control platform may have a tabular format.

In some cases, source data (e.g., tables) may reside in external computing systems, such as external cloud computing platforms (e.g., platforms provided by Snowflake and/or Databricks). The data warehouse may ingest source data (e.g., tables) from connected data sources. In some cases, source data (e.g., tables) may include comma separated value (csv) and/or parquet snapshots that can be used to run modeling experiments, such as feature set tuning.

“Event data” may refer to data representative of one or more discrete events (e.g., business events), each measured at a respective point-in-time. In some embodiments, event data are organized or encoded in a tabular format (e.g., as an event table, or as one or more rows of an event table). In some embodiments, an event table (also referred to as a “transaction fact table”) may be a data table including a number of rows, where each row is representative of a discrete event (e.g., business event) measured at a point-in-time. Each row may include one or more column values indicative of information for the event. In some embodiments, each row of an event table includes and/or is otherwise associated with a respective timestamp. As an example, the respective timestamp for an event corresponding to a row of an event table may be a timestamp at which the event occurred. The timestamp may be a Coordinated Universal Time (UTC) time. The timestamp can include a time zone offset to allow the extraction of date parts in local time. When the specified timestamp is not a timestamp with a time zone offset, a user may specify the time zone. Examples of the time zone of the data may be a single value for all data included in the event data or a column included in the event table. Some non-limiting examples of event tables include an order table in e-commerce, credit card transactions in banking, doctor visits in healthcare, and clickstream on the internet. Some non-limiting examples of common features that may be extracted from an event table can include recency, frequency and monetary metrics such as time since customer's last order, count of customer orders in the past 4 weeks and sum of customer order amounts in the past 4 weeks. Features can include timing metrics such as count of customer visits per weekday the past 12 weeks, most common weekday in customer visits the past 12 weeks, weekdays entropy of the past 12 weeks customer visits and clumpiness (e.g., overall variability) of the past 12 weeks customer visits. Features can include stability metrics such as weekdays similarity of the past week customer visits with the past 12 weeks visits. Some non-limiting examples of features that may be extracted for the event entity of the event table (e.g., an order) can include an order amount, an order amount divided by customer amount averaged over the 12 past weeks, and order amount z-score based on the past 12 weeks' customer order history.

“Item data” may refer to data representative of one or more attributes of one or more events. In some embodiments, item data are organized or encoded in a tabular format (e.g., as an item table, or as one or more rows of an item table). In some embodiments, an item table may be a data table including a number of rows, where each row is representative of at least one attribute (e.g., detail) of a discrete event (e.g., business event) measured at a point-in-time. An item table may have a “one to many” relationship with an event table, such that many items identified by an item table may correspond to a single event included in an event table. An item table may not explicitly include a timestamp. In this case, the item table is implicitly related to (e.g., associated with) a timestamp included in an event table based on the item table's relationship with the event table. Some non-limiting examples of item tables can include product items purchased in customer orders and drug prescriptions of patients' doctor visits. Some non-limiting examples of common features that may be extracted from an item table can include amount spent by customer per product type in the past 4 weeks, customer entropy of amount spent per product type over the past 4 weeks, similarity of customer's past week's basket with their past 12 weeks' basket, similarity of customer's basket with customers living in the same state for the past 4 weeks.

In some embodiments, time-series data are organized or encoded in a tabular format (e.g., as a time-series table, or as one or more rows of a time-series table). In some embodiments, a time-series table may be a data table including data collected at discrete, successive, regularly spaced (e.g., equally spaced) points in time. In some cases, rows in a time-series data table may represent an aggregated measure over the time unit (e.g., daily sales) or balances at the end of a time period. In some cases, records may be missing from a time-series data table and the time unit (e.g., hour, day, month, year) of the time-series data table may be assumed to be constant over time. In some cases, the time-series table is a multi-series where each series is identified by a time series identifier. Some non-limiting examples of common features for time-series table are aggregates over time such as shop sales over the past 4 weeks. Seasonal features are also common for time-series table. Examples of seasonal features can include the average sale for the same day over the 4 weeks, where the day is derived by the date of the forecast in the feature request data.

“Slowly changing dimension data” may refer to relatively static data (e.g., data that change slowly (e.g., infrequently), data that change slowly and unpredictably, etc.). In some embodiments, slowly changing dimension data are organized or encoded in a tabular format (e.g., as a slowly changing dimension table, or as one or more rows of a slowly changing dimension table). In some embodiments, a slowly changing dimension table may be a data table that includes relatively static data. A slowly changing dimension table may track historical data by creating multiple records for a particular natural key. Each natural key (also referred to as an “alternate key”) instance of a slowly changing dimension table may have at most one active row at a particular point-in-time. A slowly changing dimension table can be used directly to derive an active status, a count at a given point-in-time, and/or a time-weighted average of balances over a time period. A slowly changing dimension table can be joined to event tables, time-series tables, and/or item tables. A slowly changing dimension table can be transformed to derive features describing recent changes indicated by the table. Some non-limiting examples of common features that may be extracted from views based on a slowly changing dimension table corresponding to a 6 month period for a customer may include a number of times a customer has moved residences, previous locations of residences where a customer lived, distances between the present residence and each of the previous residences, an indication of whether the customer has a new job, and a time-weighted average of the balance of the customer's bank account.

“Dimension data” may refer to descriptive data (e.g., data that describe an entity). In some embodiments, dimension data are static. In some embodiments, dimension data are organized or encoded in a tabular format (e.g., as a dimension table, or as one or more rows of a dimension table). In some embodiments, a dimension table may be a data table that includes one or more rows of descriptive data (e.g., static descriptive information, such as a date of birth). A dimension table may correspond to a particular entity, where the entity is the primary key of the dimension table. A dimension table can be used to directly derive features for an entity (e.g., an individual, a business, a location, etc.) that is a primary key of the dimension table. In some cases, a dimension table may be joined to an event table and/or an item table. In some cases, new rows may be added to a dimension table. Based on the addition of new rows to a dimension table, no aggregation may be applied to a dimension table as the addition of new records can lead to training and serving inconsistencies.

In some embodiments, a user may register a new data source (e.g., source table) with the feature engineering control platform via the data annotation and observability facility. For example, a user may connect an external cloud data source with the feature engineering control platform. Source data (e.g., tables) provided from data sources connected to the feature engineering control platform may be received and stored by the data warehouse. When the user connects and registers a new data source, the user may tag the new table(s) provided from the new data source. The user may tag the new table(s) as corresponding to a particular data type described herein. In some cases, different data provided by a particular data source may correspond to different data types. As an example, a user may tag the primary key for a dimension table; the natural key for slowly changing dimension table, the slowly changing dimension table's effective timestamp, and optionally the slowly changing dimension table's active flag, and the end timestamp of a row's activity period; the event key and timestamp for an event table; the item key, the event key, and the event table associated with an item table; the sensor key and timestamp for sensor table; and the time series identifier for the multi time-series table, its date or timestamp, and its corresponding time unit and format.

In some embodiments, the feature engineering control platform may prompt the user to provide the above-described tags. In some cases, during registration of time-series table from a new data source, a user may annotate the time unit and format of the time-series data date or timestamp. Some examples of supported time units for time-series data (e.g., a time-series table) may include multiples of one minute, one hour, one day, one week, one month, one quarter, and one year units. Some examples of supported date-times may be a year, year-quarter, year-month, date, and timestamp with a time zone offset. When a time unit for time-series data is a week, date-time may be the first day of the week. When a time unit for time-series data is less than or equal to one hour, the date-time may be a timestamp with a time zone offset. When a time unit for time-series data is less than or equal to one hour, the timestamp may be assumed to indicate the beginning of the time period and may be changed by a user. When the specified date-time format for time-series data is not a timestamp with a time zone offset, a user may specify the time zone of the date. Examples of the time zone of the data may be a single value for all data included in the time-series table or a column included in the time-series table.

In some embodiments, time-series data (e.g., a time-series table) may be derived from event data (e.g., an event table). A time-series table can be derived from an event table based on a selection of an entity, a column, an aggregation function, and a time unit from the event table. Based on the selection, a time-series table may be generated and metadata for the time-series table may be automatically inferred.

In some cases, during registration of an event table from a new data source (e.g., source table), a user may annotate a record creation timestamp for the event data included in the event table. In some embodiments, the feature engineering control platform may prompt the user to provide such annotation. Annotation of a record creation timestamp may automatically cause analysis of event data availability and freshness. Analysis of the event data availability and freshness may enable automated recommendation of settings for feature job scheduling by the feature job orchestration facility. Recommendation of a default setting for feature job scheduling may abstract the complexity of setting feature jobs of features extracted from the event table. Additional features of automatic feature job scheduling are described herein at least in the section titled “Exemplary Techniques for Automated Feature Job Setting.”

In some embodiments, with respect to data semantics, the data annotation and observability facility may enable identification of semantics of data fields included in the received source data (e.g., data fields of tables). Each data source registered with the feature engineering control platform may include or be associated with a semantic layer that captures and accumulates the domain knowledge acquired by users interacting with the same source data. In the semantic layer, semantics for data fields included in received source data may be encoded based on a data ontology configured to enable improved feature engineering capabilities. The ontology and semantics described herein may characterize data fields of source data received from each data source. Data fields of source data (e.g., columns of tabular data) may be characterized to correspond to one or more of the levels (e.g., all applicable levels) for the hierarchical tree-structure of the ontology described herein.

In some embodiments, during and/or after registration of a table, a user may tag the table provided from the data source. The user may tag individual data fields (e.g., columns) and/or groups of data fields of the table with respective semantic types of a data ontology as described herein. In some cases, the feature engineering control platform may prompt the user to provide the data ontologies for data fields of the table. Data ontologies for data fields of the table may be provided via a graphical user interface and/or an SDK of the feature engineering control platform.

### First Example of a Data Ontology

In some embodiments, with respect to data ontology, an ontology (or taxonomy) applied to data fields of a table by the data annotation and observability facility may have a hierarchical tree-based structure, where each node included in the hierarchical tree-structure represents a particular semantics type corresponding to specific feature engineering practices. The tree-structure may have an inheritance property, where a child node inherits from the attributes of the parent node to which the child node is connected. The tree-structure may include a number of levels. Nodes of a first level of the tree-structure may represent basic generic semantics types associated with incompatible feature engineering practices and may include a numeric type; a binary type; a categorical type; a date-time type; a text type; a dictionary type; and a unique identifier type.

In some cases, nodes of second and third levels of the tree structure may represent more precise generic semantics for which additional feature engineering is commonly used. Nodes of a fourth level of the tree structure may be domain-specific.

In some embodiments, for the numeric type, the nodes of the second level connected to the numeric type may determine whether particular operations may be applied to the data field of the table characterized with the numeric type to generate features. Examples of the operations can include whether a sum can be used, average can be used, a weighting can be used, and/or circular statistics should be used on the data field characterized with a numeric type. Nodes of the second level that are connected to the numeric type may include additive numeric type nodes, semi-additive numeric type nodes, non-additive numeric type nodes, ratio/percentage/mean type nodes, ratio numerator/ratio denominator type nodes, and/or circular type nodes. For an additive numeric type node, sum aggregation operations may be recommended, in addition to mean, maximum, minimum, and standard deviation operations. An example of an additive numeric type of data field is a field indicating customer payments for purchases. For a semi-additive numeric type node, sum aggregation operations may be recommended at a point-in-time (e.g., only at a point-in-time). Examples of semi-additive numeric types of data field include an account balance or a product inventory. For a non-additive numeric type node, mean, maximum, minimum, and standard deviation operations may be commonly used, but a sum operation may be excluded. An example of a non-additive numeric type of data field is a field indicating customers' ages. For a ratio/percentage/mean type node, weighted average and standard deviation operations may be recommended, and unweighted maximum and minimum operations may be recommended. A sum operation may be excluded for this type. For a ratio numerator/ratio denominator type node, a ratio may be derived, two or more sum aggregations may be derived, and the ratios of any two of the sums may be recommended. An example of a ratio numerator/ratio denominator type of data field is moving distance and moving time, where the ratio is a speed at a given time from which a maximum speed can be extracted, the sums are travel distance and travel duration, and the ratio of the sums is the average speed. For a circular type node, circular statistics may be recommended. Examples of data fields of a circular type can include a time of a day, a day of a year, and a direction.

In some embodiments, for the non-additive numeric type, the nodes of the third level connected to the non-additive numeric type may include a measurement-of-intensity node, an inter-event time node, a stationary position node, and/or a non-stationary position node. A measurement of intensity node may indicate the intensity or other value of a measurable quantity (e.g., temperature, sound frequency, item price, etc.). For a measurement of intensity node, change from a prior value may be derived. For an inter-event time node, clumpiness (e.g., a variability of event timings) may be applied. A stationary position node may represent the position (e.g., geographical position) of a stationary object (e.g., using latitude/longitude coordinates or any coordinates of any other suitable coordinate system). For a stationary position node, distance from another location (e.g., another location node) may be derived. A stationary position node may represent the position of a non-stationary object (e.g., an object that is moving, is permitted to move, or is capable of moving). For a non-stationary position node, moving distance, moving time, speed, acceleration, and/or direction may be derived.

In some embodiments, for the additive numeric type, the nodes of the third level connected to the additive numeric type may include a positive amount node. For a positive amount node, statistical calculations grouped per the category of a categorical column may be applied, or periodic (e.g., daily, weekly, monthly) time-series may be derived.

In some embodiments, examples of domain-specific nodes of the fourth level of the tree-structure can include patient temperature nodes, patient blood pressure nodes, and/or car location nodes. For a patient temperature node, categorization operations may be applied to derive temperature categories (e.g., low, normal, elevated, fever, etc.). For a patient blood pressure node, categorization operations may be applied to derive blood pressure categories (e.g., hypotension, normal, hypertension, etc.). For a car location node, a highway on which the car is located may be detected, and categorization operations may be applied to derive movement categories (e.g., high acceleration, low acceleration, high deceleration, low deceleration, high speed, low speed, etc.).

In some embodiments, for the categorical type, the nodes of the second level connected to the categorical type may indicate whether the categorical field is an ordinal type. Examples of features extracted from categorical fields can include a count per category, most frequent, unique count, entropy, similarity features, and/or stability features. In some cases, nodes of the third level connected to the categorical type can indicate whether the categorical field is an event type. When the categorical field is an event type, operations that may be applied to the corresponding event data (e.g., event table) can include identifying the event type for each row of the event table, and generating one or more features by performing operations on rows having the same event type.

In some embodiments, domain specific nodes of the fourth level can indicate further feature engineering and related best practice operations that may be applied to the source data (e.g., table). For example, for a zip code, a best practice may include concatenating the zip code with a data field having a country semantics type. For a city, a best practice may include concatenating the city with a data field having state and country semantics types. For an ICD-10-CM, a best practice may include extracting the first three symbols of ICD-10-CM.

In some embodiments, for the date-time type (e.g., a timestamp), operations applied to the data field corresponding to the date-time type may include extracting date parts such as a year, month of a year, day of a month, day of a week, hour of a day, time of a day, and/or day of a year. The nodes of the second level connected to the data-time type may indicate whether the timestamp is an event timestamp type, a start date, or an end date. The nodes of the third level connected to the event timestamp type may indicate whether the event timestamp type is a measurement event timestamp or a business event timestamp. A measurement event timestamp may be the timestamp of measurement that occurs at predictable (e.g., periodic or threshold) intervals (e.g., in sensor data). A business event timestamp may be the timestamp of a discrete business event measured at a point-in-time. Examples of business event timestamps can include order timestamps in e-commerce, credit card transactions timestamp in banking, doctor visits timestamps in healthcare, and click timestamps on the internet. For a business event timestamp, examples of extracted features can include a recency with time since a last event, the clumpiness of events (e.g., variability of inter-event time), an indication of how a customer's behavior compares with other customers, and/or indications of changes in the customer's behavior over time.

### Second Example of a Data Ontology

In some examples, a data ontology applied to data fields of a table by the data annotation and observability facility may have a hierarchical tree-based structure, where each node included in the hierarchical tree-structure represents a particular semantics type corresponding to specific feature engineering practices. The tree-structure may have an inheritance property, where a child node inherits from the attributes of the parent node to which the child node is connected. The tree-structure may include a number of levels. Nodes at a first level of the tree-structure may represent basic and/or generic semantic types associated with incompatible feature engineering practices and may include a numeric type; a binary type; a categorical type; a date-time type; a text type; a dictionary type; and a unique identifier type.

In some cases, nodes of an intermediate level (e.g., levels 2 and 3) of the tree structure may represent more precise generic semantics for which advanced feature engineering is commonly used. Nodes of a fourth level of the tree structure may be domain-specific. Some first level nodes may connect to one or more level 2 nodes, which in turn may connect to level 3 nodes, which themselves may connect to level 4 nodes. Nodes may or may not include connections to nodes of more specific types. For example, a level 1 node may connect to several level 2 nodes that themselves do not connect to level 3 nodes. As an additional example, a level 1 node may connect to several level 2 nodes, some of which connect to level 3 nodes. Some of those level 3 nodes in turn may connect to level 4 nodes. Of note, root or first level node types are alone often not precise enough to guide the feature engineering principles described herein. Thus, a data ontology can include child nodes that inherit the properties of their parent nodes, and these child nodes can be used to guide feature engineering more precisely.

Nodes at the first level of the tree-structure can include a variety of type identifiers and/or be of a variety of types. For example, a level 1 node can have a “unique identifier type” that includes a unique identifier that uniquely identifies the table record, such as user IDs, serial numbers, and the like. Unique identifier nodes can connect to level 2 nodes that are identified during the table registration process, such as “event ID,” “item ID,” “dimension ID,” “surrogate key,” “natural key,” and/or “foreign key” types.

Level 1 nodes can also be of an “numeric” type which includes numeric data with values applicable for statistic operations such as mean and standard deviation. Integers used as category labels are generally excluded from this type. Level 2 nodes associated with numeric types can determine whether summation and/or circular statistics functions can be applied to the data. In one example, level 2 subtypes of numeric types can include “non-additive numeric” types for which mean, max, min, and/or standard deviation statistical functions are commonly used, but summation functions are not. As a specific example, non-additive numeric types can be customer ages. Non-additive numeric types can connect to level 3 subtypes or nodes, such as a “measurement of intensity” type (e.g., temperature, sound frequency, item price, etc.) for which a change from a prior value can be derived. Some examples of level 4 nodes connected to measurements of intensity include “patient temperature” which can be categorized into ranges such as low, normal, and fever. Additional examples include “patient blood pressure” for which range categorizations such as hypotension, normal, and hypertension can be derived.

Level 2 numeric type nodes also include “semi-additive numeric” types for which sum aggregation is recommended only at specific points in time, such as for account balances or product inventories.

Some level 2 numeric type nodes can be of an “additive numeric type”, in which case sum aggregation is recommended in addition to mean, max, min, and/or standard deviation statistical functions. For example, an additive numeric type can be customer payments for purchases. Additive numeric types can connect to level 3 nodes such as “non-negative amount” types for which statistics grouped by categorical columns can be applied.

In some embodiments, numeric type nodes can connect to “inter-event distance types”, for which sum aggregation can be done (differentiated from common distances which may be categorized as non-additive numeric nodes).

In further examples, numeric type nodes can connect to “inter-event time nodes.” These data types are suitable for applying distribution metrics to measure behavior, such as marathon-watching patterns for users of streaming services. These nodes can in turn connect to level 3 nodes such as “inter-event moving time,” which can help determine whether using sum aggregation on the data is likely to yield meaningful insights.

In some examples, ambiguous number type nodes can connect to “circular type” nodes which represent data for which circular statistics are usually needed. For example, circular type data can include a time of day, a day of a year, and/or a direction.

In some examples, a first level node can be of a “binary” type that has data of one of two distinct values (e.g., 0 or 1).

In some embodiments, a first level node can be of a “categorical type,” which includes data with a finite set of categories represented as integers or strings. In these embodiments, level 2 nodes of the categorical type can include an “ordinal” type. Operations such as minimum, median, maximum, and/or mode calculations can be applied to features of this type and other features commonly extracted from categorical features. Level 3 categorical type nodes can identify whether a particular feature is an “event status” or an “event type” feature. In these cases, data can be divided into subsets for each particular event type or event status.

In some embodiments, first level nodes can have an “ambiguous categorical” type, which includes data with unclear or overlapping definitions. For example, an ambiguous categorical type can include city names that are not accompanied by state or country information, resulting in difficulty determining the exact city being referenced due to the existence of multiple cities with identical names in different regions. Additionally or alternatively, an ambiguous categorical type can be used for categorical records entered in non-standardized formats.

In some embodiments, a first level node can be of a “text” type, which includes textual data that can be used for complex processing applications such as natural language processing. Level 2 nodes of the text type can include “special text” nodes, which can be subdivided into level 3 nodes such as “street address,” “URL,” “email,” “name,” “phone number,” and/or “software code” types. Other level 2 text-type nodes include ‘long text” nodes, which can connect to level 3 nodes such as “review,” “twitter post,” “resume,” or “description” types. Other level 2 text types can also include “numeric-with-unit” types.

In some examples, a node can have a “date/time” type that includes data representing dates and times. These nodes may require additional semantic processing to determine the exact date or time being referenced. Level 2 nodes connected to date/time types can help determine whether a field is a special field related to a table type or a different kind of data. Table-specific date/time level 2 node types include “event timestamp,” “record creation timestamp,” “effective timestamp,” “end timestamp,” “sensor timestamp,” “time series timestamp,” and “time series date.” Other examples include “timestamp field,” “date field,” and “year.” Level 3 nodes associated with the date/time type include “date of birth,” which is important to derive age and other age-related features. Other level 3 nodes include “start date” which can be used to create recency features, and “termination date” which can be used to divide data to create count features as a point in time.

In some embodiments, a node can have a “coordinates” type, indicating a particular location or position using a coordinate mapping. For example, a coordinate type node can include geographic data such as latitude and/or longitude values. Level 2 coordinate-type nodes include “local longitude” and “local latitude” types. These types can be subjected to approximation or other simple mathematical operations (e.g., statistical mean). Level 3 coordinate-type nodes can identify whether the coordinates correspond to the coordinates of a moving object. Features with moving object types can be transformed into statistics on object speed or other movement-related measurements.

In some cases, a first level node can be of a “unit” type, representing data indicating units of measurement.

In further embodiments, a node can have a “converter” type, representing data that is used to convert of map between different units or types. For example, a converter type can include conversion rates between currencies.

In some examples, a node can have a “list” type, representing data that is presented in a list format and containing multiple items.

In some embodiments, a node can represent a “dictionary” type, representing data stored in a key-and-value pair format.

In further examples, a node can include a “sequence” type, representing an ordered list of elements.

In some examples, a node can include a “non-informative” type. Non-informative types can represent data with minimal analytical value and can also be used to indicate data that should not be used for feature engineering.

In some embodiments of the above-described ontologies, for the text type, the nodes of the second level connected to the text type may indicate whether the text field is a special text type or a long text type. The nodes of the third level connected to the special text type can include node types for address, uniform resource locator (URL), email address, name, phone number, software code, and/or position (e.g., latitude and longitude). The nodes of the third level connected to the long text type can include node types for review, social media message, diagnosis, and product descriptions.

In some embodiments, for the dictionary type, the nodes of the second level connected to the dictionary type may indicate whether the dictionary field is a dictionary of non-positive values, dictionary of non-negative values, or dictionary of unbounded values. The nodes of the third level connected to the dictionary non-negative values type can include node types for bag of sequence n-grams, dictionary of items count, and/or dictionary of items positive amount. The nodes of the fourth level for the dictionary type can include node types for bag of words n-grams, bag of click type n-gram, bag of diagnoses code n-grams, dictionary of product category count, and/or dictionary of product category positive amount. As used herein, in the context of natural language processing (NLP), “N-gram” may refer to a contiguous sequence of N items from a text or speech sample. For purposes of text analysis, these items can be words, letters, or symbols (e.g., characters). The value of N determines the length of the sequences, with bigrams (2-grams), trigrams (3-grams), etc., representing sequences of 2 items, 3 items, and so on. As used herein, “sequence N-gram” is a generalization of the N-gram concept from NLP. Instead of limiting the items to words, letters, or symbols, sequence N-grams can include other types of sequential events or items. Sequence N-grams can be applied in various domains, where analyzing the sequence of events can reveal patterns or trends. As used herein, a “click type N-gram” is a specific type of N-gram used for user interaction analysis. A click type N-gram may include a sequence of click-based user-interface actions (e.g., ‘add to cart,’ ‘remove item,’ ‘navigate to page,’ etc.) initiated by a user via a user interface. Click type N-grams can be especially useful in understanding user behavior on websites or applications. As used herein, “diagnosis code N-gram” refers to a sequence of medical diagnoses codes. Any suitable type of medical diagnose code can be used (e.g., the codes specified in the ICD-10 classification). In healthcare data analysis, diagnosis code N-grams can be used to analyze and characterize patterns in disease progression, comorbidities, or treatment sequences.

In some embodiments, views may inherit and/or otherwise include the data ontology of source data (e.g., tables) used to generate the views. As described herein, data fields (e.g., columns) of source data (e.g., tables) may be tagged with annotations of data types corresponding to a data ontology. When source data are transformed and/or otherwise manipulated to generate a view, the view may include the data ontology of the data fields of the source data used to generate the view. In some cases, a view may inherit and/or otherwise include the data ontology of other view(s) that have been joined to the view. Data fields (e.g., columns) included in a view that are derived by one or more transformations may include a data ontology that is based on the type of transformation(s) used to generate the data field. The data annotation and observability facility may automatically assign a data ontology to new data fields included in views that are derived from one or more transformations based on the data ontology of data fields used to generate the new data fields.

In some embodiments, similar to tagging of semantic types of data fields of source data (e.g., tables) in accordance with a data ontology, a user may tag data fields of a view. The user may tag data fields (e.g., columns) of a view with respective semantic types as described herein. In some cases, a user may override an existing tag indicating a semantic type for a data field of a view. In some embodiments, the feature engineering control platform may prompt the user to provide the semantic types for data fields of views that lack existing annotations of semantic types. Semantic types for data fields of views may be provided via a graphical user interface and/or an SDK of the feature engineering control platform.

In some cases, the data annotation and observability facility may enable tagging of entities to a set of source data (e.g., a table) to establish connections between the entities and the source data. As described herein, an entity may be a logical or physical identifiable object of interest. To establish a connection between an entity and the source data, a user may tag fields (e.g., columns) of the source data (e.g., table) that are representative of the entity in the connected data sources (e.g., source tables). Columns tagged for a given entity may have different names (e.g., custID and customerID both referring to a customer identifier) and an entity may have one unique serving name (also referred to as a “serving key”) used for feature requests (e.g., received from an external artificial intelligence model). In some cases, when no feature is associated with an entity, tagging of tables corresponding to an entity may be encouraged based on the tagging aiding in recommendation of joins and features. When no feature is associated with an entity, a column tagged for the entity can typically be a primary (or natural) key of a data table received from a data source.

In some embodiments, the data annotation and observability facility may automatically establish child-parent relationships between entities. Child-parent relationships may be used to simplify feature serving, to recommend features from parent entities for a use case, and/or to suggest similarity features that compare the child and parent entities of a child-parent relationship. In some cases, an entity may be automatically set as the child entity of other parent entities when the entity's primary key (or natural key) references a data table in which columns are tagged as corresponding (e.g., belonging) to other entities. In some cases, users may establish subtype-supertype relationships between entities. An entity subtype may inherit attributes and relationships of the entity supertype. As examples of subtype-supertype relationships, a city entity type may be the supertype of a customer's city, merchant's city, and destination's city entity type and people entity type may be a supertype of a customer and an employee entity type.

In some embodiments, an entity may be associated with a feature. An entity associated with a feature defined by an aggregate may be the entity tagged to the aggregate's GroupBy key. When more than one key is used in GroupBy, a tuple of entities can be associated with a feature. In some cases, when a feature is defined via a column of a data table or a view, the feature's entity is the table's primary key (or natural key). When a feature is derived from multiple features, the entity of the respective feature may be the lowest-level child entity.

In some embodiments, an entity related to business events (e.g., complaints or transactions) may be referred to as an “event entity” in the feature engineering control platform. For use cases that are related to an event entity, features may be served using windows of time that exclude the event of the request. For example, for a use case of a transaction fraud detection, a windowed aggregation implementation of the feature engineering control platform may ensure the feature windows of time exclude the current transaction and avoid leaks when comparing the current transaction to previous transactions.

In some embodiments, a feature can be served by providing the serving name of the feature entity and the instances of the entity desired. In some embodiments, for a historical feature request, the points-in-time of each instance are provided in the historical feature request. The points-in-time may not be provided for an online feature request based on a point-in-time of an online feature request being equal to the time of the online feature request. When the entity is an event entity, at least some information relevant to serving a feature online may not have been received and recorded in the data warehouse at inference time for an artificial intelligence model. At least some information relevant to serving a feature may not have been received and recorded in the data warehouse based on the data warehouse not receiving source data in real-time. In this case, the feature engineering control platform may prompt the user to provide the missing information as part of the online feature request. When the feature entity has one or more child entities, the feature can also be served via any of the one or more child entities. The serving name of the child entity and its entity instances may be provided in place of the serving name of the feature entity and its entity instances.

In some embodiments, with respect to data cleaning, the data annotation and observability facility may enable cleaning of data received from connected data sources (e.g., source tables). In some cases, users may annotate and tag received data to indicate a quality of the source data at a table level. In some cases, users may declare one or more data cleaning steps performed by the data annotation and observability facility for received source data. In some cases, declaration of data cleaning steps can include declaring how the data annotation and observability facility can clean source data including: missing values, disguised values, values not in an expected set, out of boundaries numeric values and/or dates, and/or string values received when numeric values or dates are expected. In some cases, users can define data pipeline data cleaning settings to ignore values with quality issues when aggregations are performed or impute the values with quality issues. If no data cleaning steps are explicitly specified by a user, the data annotation and observability facility may automatically enforce imputation of data values with quality issues.

In some embodiments, a declarative framework facility of the platform provider control plane may perform functions relating to definition of features and targets (e.g., including definition of temporal parameters for features and targets) and specification of data transformations performed on source data (e.g., tables), features, and targets.

In some embodiments, the declarative framework facility may enable generation of views based on application of one or more data transformations to source data (e.g., tables). With respect to views that can be generated based on data transformations applied to source data (e.g., tables) via the declarative framework facility, the data transformations may be translated by the execution graph facility as a graphical representation of intended operations referred to as an “execution graph,” “query graph,” and “execution query graph.” The execution graph may be converted into platform-specific SQL (e.g., SnowSQL or SparkSQL). The data transformations may be executed when their respective values are needed, such as when a preview or a feature materialization is performed. As described herein, a view may inherit and/or otherwise include the data ontologies of tables and/or other views that are used to generate the view.

In some embodiments, for the feature engineering control platform, transformations can be applied to a view object where cleaning can be specified; new columns can be derived; lags can be extracted; other views can be joined; views can be subsetted; columns can be edited via conditional statements; changes included in a slowly changing dimension table can be converted into a change view; event views can be converted into time-series data; and time-series data can be aggregated.

In some embodiments, views may be automatically cleaned based on the information collected during data annotation (e.g., as described with respect to the data annotation and observability facility). Users can override the default cleaning by applying the desired cleaning steps to the source data received from the data source (e.g., source table).

In some embodiments, a number of transforms can be applied to columns included in a view by the declarative framework facility. In some cases, a transform may return a new column that can be assigned (e.g., appended) to the view or be used for further transformations. In some cases, some transforms may be available only for certain data types as described herein. In some cases, a generic transform may be available for application to columns of all data types described herein. Examples of generic transforms can include isnull (e.g., get a new boolean column indicating whether each row is missing); notnull (e.g., get a new boolean column indicating whether each row is non-missing); fillna (e.g., fill missing value in-place); and astype (e.g., convert the data type).

In some cases, a numeric transform may be available for application to a numeric column and may return a new column. Examples of numeric transforms can include built-in arithmetic operators (+, −, *, /, etc.); absolute value; square root; power; logarithm with natural base; exponential function; round down to the nearest integer; and round up to the nearest integer.

In some cases, a string transform may be available for application to a string column and may return a new column. Examples of string transforms can include get the length of the string; convert all characters to lowercase; convert all characters to uppercase; trim white space(s) or a specific character on the left & right string boundaries; trim white space(s) or a specific character on the left string boundaries; trim white space(s) or a specific character on the right string boundaries; replace substring with a new string; pad string up to the specified width size; get a Boolean flag column indicating whether each string element contains a target string; and slice substrings for each string element.

In some cases, a date-time transform may be available for application to a date-time column. Examples of date-time transforms can include calculate the difference between two date-time columns; date-time component extraction (e.g., extract the year, quarter, month, week, day, day of week, hour, minute, or second associated with a date-time value); and perform addition with a time interval to produce a new date-time column.

When date-time transforms are applied to a timestamp with a time zone offset, date parts (e.g., day of week, month of year, hour of day) can be extracted based on the local time zone. In some cases, for a given entity corresponding to a table, lags can extract a value of a previous row for the same entity instance as a current row. Lags may enable computation of features that are based on inter-event time and distance from a previous point. Seasonal lags for the same time-series identifier can be extracted in time-series data (e.g., a time-series table). For example, users may define a 7 day frequency period to generate lag for the same day of a week as the current. Users can also choose to skip the missing records or impute the missing records. In some cases, to facilitate time-aware feature engineering, the event timestamp of the related event data may be automatically added to an item view by a join operation. Other join operations may be recommended for application to a view when an entity indicated by the view (or the entity's supertype) is a primary key or a natural key of another view. In some cases, joins of slowly changing dimension views may be made at the timestamp of the calling view. In some cases, the declarative framework facility may enable condition-based subsetting, such that views can be filtered. A condition-based subset may be used to overwrite the values of a column in a view. In some cases, the declarative framework facility may enable joins of calendar data (e.g., a calendar table) to times-series views or event views. A join of a calendar table to a time-series table may be backward or forward. A suffix may be added to the added column to indicate a non-null offset.

In some embodiments, cross-time-series identifier aggregation may be performed for a parent entity, which may generate new time-series data (e.g., a new time-series table or view). In some cases, a change to a larger time unit for time-series data (e.g., a time-series table) may be supported. Changing to a larger time unit may create a new view based on a time-series table, where the serving name of the time-series table date-time column may be specified (e.g., by a user via the graphical user interface). Changing to a larger time unit may cause generation of a new feature job setting based on a time zone when the new time unit is a day or larger than a day.

In some embodiments, changes in a slowly changing dimension table can indicate powerful features, such as a number of times a customer moved address in the past 6 months, previous residences of the customer, a change in marital status of the customer, a change in a number of a customer's children, and/or changes to a customer's employment status. To generate such types of features, users can generate a change view from a slowly changing dimension table, where the change view may track changes for a given column of the slowly changing dimension table. Features may be generated from the change view similar to generation of features from an event view. In some cases, the change view may include four columns including a change timestamp (e.g., equal to the effective timestamp of the slowly changing dimension table); the natural key of the slowly changing dimension view; a value of the column before the change; and a value of the column after the change.

In some embodiments, the declarative framework facility may enable generation of features. The declarative framework facility may cause generation of features from views based on optional data manipulation operations applied to views. In some cases, the declarative framework facility may generate lookup features. When an entity is the primary key of a view, a column of the view can be directly converted into a lookup feature for the entity. Some non-limiting examples of lookup features can include a customer's place of birth and a transaction's amount (e.g., dollar amount). When a unit of analysis of a feature is the natural key of a slowly changing dimension view, a column of the view may be directly converted into a lookup feature. In this case, the feature may be materialized based on point-in-time join operations. The value served for the feature may be the row value active as of the point-in-time of the request. Some non-limiting examples of lookup features from a slowly changing dimension view can include a customer's marital status at a point-in-time of a request or at a historical point-in-time that is before the point-in-time of the request.

In some embodiments, date parts of the time-series table date-time column or columns derived from calendar join operations may be converted into lookup features. Other columns of the time-series data may be converted into lookup features when the columns from which the lookup features are derived have been tagged as “known in advance” and the instances of those columns may be provided as part of an online request data. All lookup features in time-series may be associated with an entity tuple that includes the time-series identifier for the time-series table and the serving name of the time-series table date-time column. When a request is received at the feature store facility, instances of the time-series table date-time column may be provided in the request data with the time-series identifier. The instances of the time-series table date-time column provided in the request data can typically represent the date of the time-series forecast.

In some embodiments, the declarative framework facility may generate aggregate features. When a target entity is not the primary (or natural) key of a view, features (referred to as “aggregate features”) may be defined via aggregates where an entity column is used as the GroupBy key. For a sensor view, a time-series view, an event view, and an item view, the aggregates may be defined by windows (e.g., corresponding to periods of time) that are prior to the points in time of the request for the feature. Windows used in windowed aggregation can be time-based windows and/or count-based. Some non-limiting examples of aggregate features can include a “customer sum” (e.g., a sum of the order amounts of a customer's orders over the most recent 12 weeks, a sum of the order amounts of the customer's most recent 5 orders, etc.). In some cases, windows can be offset backwards to enable and allow for aggregation of any period of time in the past. An example of such feature can include a customer sum of order amounts from a period of 12 weeks ago to 4 weeks ago (e.g., an 8 week period of time). In a time-series view, windowed aggregations may be performed when (e.g., only when) the time-series identifier of time-series view is defined as the GroupBy key and time-based windows may be a multiple of the time unit of the time-series table. In some cases, date parts operations in the aggregates may be enabled in the time-series view to restrict the aggregation to specific time periods during the window. As an example, a feature may be derived for average sales for a particular day of week over a window of the past 8 weeks. Such seasonal features can be associated with an entity tuple that includes the time-series identifier for the time-series table and the serving name of the time-series table date-time column. When a request is received at the feature store facility, instances of the time-series table date-time column may be provided in the request data together with the time-series identifier. The instances of the time-series table date-time column provided in the request data usually represent the date of the time series forecast. Supported date parts for aggregate operations using time-series data may include hour of day, hour of week, day of week, month of year, etc.

In some embodiments, for an item view, when a target entity is the event key of the view, simple aggregates can be applied to the item view to generate aggregate features. An example of such a feature is a count of items included in an order. In some cases, for a slowly changing dimension view, aggregate operations used to generate aggregate features can include aggregates as at a point-in-time, time-weighted aggregates over a window (e.g., time period), and aggregates of changes over a window. For a slowly changing dimension view and an entity that is not a natural key of the slowly changing dimension view, an aggregate operation may be applied to records (e.g., rows) of the slowly changing dimension view that are active as at the point-in-time of a request for a feature. An example of such a feature is a number of credit cards held by a customer at the point-in-time of the request. In some cases, users may be able to specify a temporal offset to retrieve a value of a feature as at some point-in-time (e.g., 6 months) prior to the point-in-time of the request. An example of such a feature is a number of credit cards held by a customer 6 months before the point-in-time of the request. For a slowly changing dimension view and an entity that is a natural key of the slowly changing dimension view, the aggregate operation applied to the slowly changing dimension view may be time-weighted. An example of such a feature is a time-weighted average of account balances over the past 4 weeks. To generate features from aggregate operations on changes, users may generate a change view from a slowly changing dimension table. Based on generating the change view, subsequent aggregate operations may be applied to the change view similar to aggregate operations applied to an event view. An example of such a feature is a number of changes of address over the past 2 years.

In some embodiments, the declarative framework facility may include and/or otherwise enable use of a number of aggregation functions to generate aggregate features. Some non-limiting examples of supported aggregation functions can include last event, count, na_count, sum, mean, max, min, standard deviation, and sequence functions. In some cases, aggregation operations per category may be defined. As an example, a feature can be defined for a customer as the amount spent by customer per product category the past 4 weeks. In this case, when the feature is materialized for a customer, the declarative framework facility may return a dictionary including keys that are the product categories purchased by the customer and respective values that are the sum spent for each product category.

In some embodiments, the declarative framework facility may enable transformation of features similar to the transformations for columns of views as described herein. In some cases, additional transforms may be supported to transform features resulting from an aggregation per category, where the feature instance is a dictionary. Examples of such transformations can include most frequent key; number of unique keys; key with the highest value; value for a given key; entropy over the keys; and cosine similarity between two feature dictionaries.

Examples of respective features that may be generated based on the above-described transforms may include most common weekday in customer visits the past 12 weeks; count of unique products purchased by customer the past 4 weeks; set of unique products purchased by customer the past 4 weeks; amount spent by customer in ice cream the past 4 weeks; and weekdays entropy of the past 12 weeks customer visits.

In some embodiments, the declarative framework facility may enable generation of a second feature from two or more features. Examples of such features can include similarity of customer past week basket with her past 12 weeks basket, similarity of customer item basket with basket of customers in the same city the past 2 weeks, and order amount z-score based on the past 12 weeks customer orders history. In some cases, the declarative framework facility may enable generation of features on-demand. Users may generate on-demand features from another feature and request data. An example of an on-demand feature may be a time since a customer's last order. In this case, the point-in-time is not known prior to the request time and the timestamp of customer's last order can be a customer feature that is pre-computed by the feature engineering control platform.

In some embodiments, features extracted from data views can be added as respective columns to a view (e.g., an event view). A feature extracted from a data view can be added as a column to an event view when the feature's entity is included in the event view. Based on adding an extracted feature as a column to an event view, values can be aggregated as described with respect to any other column of a view. An addition of a feature to a view can enable computation of features such as customer average order size the last 3 weeks, where order size is a feature extracted from an item view (e.g., order details for an order event). An addition of a feature to a view can enable generation of more complex features, such as a feature for an average of ratings for restaurants visited by a customer in the last 4 weeks. In this case, the rating for each restaurant may be a windowed aggregation of ratings for the restaurant over a 1 year period of time. To speed up the computation of such complex features, the feature engineering control platform may accommodate the addition of a windowed aggregation feature by pre-computing historical values of the added feature and storing those historical values in an offline store.

In some embodiments, features for one entity can be converted into features for one parent entity of the entity when a child-parent relationship is established via a dimension table or a slowly changing dimension table. The new feature at the parent level may be a simple aggregate of the feature at the child level based on the child entity instances that are associated with the parent entity instance as at the point-in-time of the feature request or the point-in-time of the feature request minus an offset. Examples of such features can include a maximum of the sum of transaction amount over the past 4 weeks per credit card held by a customer. In this example, a sum of transaction amount over the past 4 weeks is a feature built at the credit card level that is aggregated at the customer level.

In some embodiments, an entity supertype may inherit the features of the subtypes of the entity supertype. The inherited features may be served (e.g., to an artificial intelligence model) without explicit specification of the subtype serving name and instance, such that only the supertype serving name and instance may be provided at serving time. In some cases, features from an entity supertype (or another subtype of the entity supertype) may not be used directly by the entity subtype of the entity supertype. Features from an entity supertype may be converted for use by the entity subtype of the entity supertype.

In some cases, the declarative framework facility may enable generation of use cases. As described herein, a use case can describe a modeling problem to be solved and can define a level of analysis, the target object, and a context for how features are served. A use case may include a target recipe including a horizon and/or a blind spot for the target object, as well as any data transformations performed on the target object. Examples of use cases can include a churn of active customers for the next 6 months and fraud detection of transactions before payment. Formulation of use cases by the declarative framework facility may better inform users of the feature engineering control platform of the context of feature serving. When a use case is associated with an event entity, the feature engineering control platform and the declarative framework facility may be informed on the need to adapt the serving of features to the context. In some cases, the declarative framework facility may support the mathematical formulation of use cases via the formulation of a context view and a target recipe, where a use case is defined based on a context view and target recipe. Based on mathematical formulation of use cases, observation sets (also referred to as “observation datasets”) specifically designed for the use cases may be generated for exploratory data analysis (EDA) of the features, training, retraining, and/or testing purposes as described herein at least in the section titled “Exemplary Techniques for Automatic Generation of Observation Sets.”

In some embodiments, use case primary entities may define a level of analysis of a modeling problem (e.g., modeling problem to be modeled by an artificial intelligence model). A use case may typically be associated with a single primary entity. In some cases, a use case may be associated with more than one entity. An example of a use case associated with more than one entity is a recommendation use case where two entities are defined for a customer and a product. Based on entity relationships of the use case entities (e.g., parent-child entity relationships and supertype-subtype entity relationships), the declarative framework facility may automatically recommend parent entities and subtype entities for which features can be used or built for the use case. The features can indeed be directly served with the use case entities as the use case entities instances uniquely identify the instances of the parent entity or the subtype entity that defines the features. As an example, for a fraud detection use case where the primary entity is a transaction, features can be also extracted from the merchant entity, the credit card entity, the customer entity, and the household entity each corresponding to the transaction. Based on entity relationships of the use case entities, the declarative framework facility (or feature discovery facility) may also automatically recommend a data model of the use case. The data model of the use case may indicate (e.g., identify, list, etc.) all source data (e.g., tables) that can be used to generate features for the use case entity, the use case entity's parent entities, and/or the use case entity's subtype entities. Eligible tables may include tables where either the use case entities, the parent entities, the subtype entities, or their respective child or subtype entities are tagged.

In some embodiments, a context may define and indicate the circumstances in which a feature is expected to be served. Examples of contexts can include an active customer that has made at least one purchase over the past 12 weeks and a transaction reported as suspicious from a time period of reporting of the suspicious transaction to case resolution of the suspicious transaction. With respect to context formulation, minimum information provided by users to register and generate a context may include an entity to which the context is related, a context name, and a description of the context. In some cases, users may provide an expected inference time or expected inference time period for the context and a context view that mathematically defines the context. As an example, expected inference time can be any time (e.g., duration of time) or a scheduled time (e.g., scheduled duration of time). In some cases, an expected inference time may be an expected inference time period such as every Monday between 12:00 pm to 4:00 pm.

In some embodiments, a context view of a context may define the time periods during which each instance of the context entity is available for serving. An entity instance can be associated with multiple periods (e.g., non-overlapping periods). A context view may include respective columns for an entity serving key, a start timestamp, and an end timestamp. The end timestamp may be null when the entity key value is currently subject to serving (e.g., when a customer is active now). A context view may be generated in the data warehouse from source data or tables via the SDK of the feature engineering control platform. A context view may be generated via the SQL code received from a client computing device connected to the feature engineering control platform. In some cases, a context view may be generated via alternative techniques. In some cases, operations such as leads (e.g., where leads are opposite of lags as described herein) may be included in the SDK for a context view. In some cases, a context view can be treated as a slowly changing dimension table to retrieve entity instances (e.g., rows of table data corresponding to the entity) that are available for serving at any given point-in-time. A context view may be used by the feature engineering control platform to generate observation sets on-demand as described at least with respect to “Exemplary Techniques for Automatic Generation of Observation Sets.” In some embodiments, the context view is provided by a user, and the process of generating an observation set based on the context view has the effect of materializing (as the observation set) the context corresponding to the context view.

In some embodiments, a context may be associated with an event entity. When the context entity is an event entity, the information (e.g., context view and/or expected inference time or time period) corresponding to as context may be used by the feature engineering control platform to ensure that an end of a window of a feature aggregate operation is before a particular event's timestamp, thereby avoiding inclusion of the event in the aggregate operation used to generate a feature value. Such use of the context information may be critical for use cases (e.g., fraud detection) where useful features can include comparing a particular transaction with prior transactions. In some cases, further feature engineering may be used for context(s) associated with an event entity. For example, features may be generated based on an aggregation of event(s) that occurred after a particular event and before a point-in-time of the feature request.

In some embodiments, the declarative framework facility may enable generation of target objects (also referred to as “targets”). A target object may be generated by a user by specifying a name of the target object and the entities with which the target object is associated. In some cases, for a target object, users may provide a description, a window size of forward operations or an offset from a slowly changing dimension table (each referred to as a “horizon”), a duration between a timestamp corresponding to computation of a target and a latest event timestamp corresponding to the event data used to compute the target (referred to as a “blind spot”), and a target recipe. A target recipe for a target may be defined similar to features as described herein. In some cases, a target recipe can be defined from (e.g., directly from) a slowly changing dimension view. In this case, users can specify an offset to define how much time in the future a status may be retrieved for the slowly changing dimension view. An example of such a target recipe may be marital status in 6 months. An example of a target defined by an aggregate as at a point-in-time may be a count of credit cards held by customer in 6 months.

In some embodiments, a target recipe can involve a forward aggregate operation. A forward aggregate operation for a target object may be defined similar to windowed aggregations generated from event views, time-series views and item views, or time-weighted aggregates over a window from slowly changing dimension views. To define a forward aggregation operation for a target object, users specify that the window operation is a forward window operation.

In some embodiments, a feature discovery facility of the platform provider control plane may enable users to perform automated feature discovery for features that may be served by the feature engineering control platform. Semantic labels assigned to source data (e.g., columns of tables) by the data annotation and observability facility may indicate the nature (e.g., ontology) of the source data. The declarative framework facility as described herein may enable users to creatively manipulate source data (e.g., tables) to generate features and use cases. A feature store facility may enable users to reuse generated features and push new generated features into production for serving (e.g., serving to artificial intelligence models). Based on the above-described facilities, the feature discovery facility may enable users to explore and discover new features that can be derived from source data (e.g., tables) stored by the data warehouse.

In some embodiments, feature discovery using the feature discovery facility may be governed based on one or more principles. As an example, the feature discovery facility may (1) enable suggestion of meaningful features (e.g., without suggesting non-meaningful features); (2) adhere to feature engineering best practices; and (3) suggest features that are inclusive of important signals of source data. The feature discovery facility may rely on the data semantics added to source data (e.g., tables) to generate suggested features. If no data semantics are annotated to source data (e.g., a table), the feature discovery facility may not be able to generate suggested features. The feature discovery facility may codify one or more best practices for the data semantics added to the source data (e.g., table). The feature discovery facility may automatically join tables based on the data transformations and manipulations described herein. The feature discovery facility may automatically search features for entities that are associated with a primary entity.

In some cases, using the feature discovery facility, users may request automated feature discovery by providing an input with the scope of a use case, a view and an entity, and/or a view column and an entity. Results of automated feature discovery performed by the feature discovery facility may include feature recipe methods that are organized based on a theme. A theme may be a tuple including information for entities associated with a feature (referred to as a “feature entities”), primary table for the feature, and a signal type of the feature. As an example, feature discovery may be performed for an input of an event timestamp of a credit card transaction table for the customer entity. In some cases, to convert the output feature recipe methods into a feature, users can call the feature recipe method directly from the use case, the view, and/or the view column. In some cases, the feature discovery facility may display, via the graphical user interface, information relating to helping a user convert the recipe method into a feature. As an example, the graphical user interface may display one or more parameters (e.g., window size) for a feature and computer code that can be used to alternatively generate the feature in the SDK.

In some embodiments, feature discovery performed by the feature discovery facility can include combining operations such as joins, transforms, subsetting, aggregations, and/or post aggregation transforms. In some cases, users may provide an input selection to decompose combined operations, such that the feature discovery facility provides suggestions for feature discovery at the individual operation level.

In some embodiments, the feature discovery facility may include a discovery engine configured to search and provide potential features based on data semantics annotated for source data (e.g., tables), the type of the data, and whether an entity is a primary (or natural) key of the table. The discovery engine may generate features recipes for a received input based on executing a feature discovery method including a series of one or more joins, transforms, subsets, aggregations, and/or post aggregation transforms on tables. In some cases, transform recipes may be selected based on the data field semantics and outputs of the transform recipes may have new data semantics defined by the transform recipes. Subsetting may be triggered by the presence of an event type field in source data (e.g., a table). Aggregation recipes may be selected based on a function of the nature (e.g., ontology) of the source data (e.g., tables), the entity, and the semantics of the table's fields and respective transforms. Post aggregation transforms recipes may be selected based on the nature of the aggregations. Additional features of a feature discovery method performed by the feature discovery facility are described herein at least in the section titled “Exemplary Techniques for Automated Feature Discovery.”

### Feature Cataloging

In some embodiments, facilities of the feature engineering control platform corresponding to feature cataloging may include data catalog, entity catalog, use case catalog and feature catalog. In some cases, the data catalog facility may include a data catalog that may be displayed via the graphical user interface. Using the data catalog, users of the feature engineering control platform may find and explore source data (e.g., tables) received from connected data sources and may add annotations to the source data (e.g., tables) (e.g., based on data semantics and data ontology as described herein). In some cases, using the data catalog, users may explore views shared by other users of the feature engineering control platform. In some cases, the entity catalog facility may include an entity catalog that may be displayed via the graphical user interface. Using the entity catalog, users of the feature engineering control platform may find and explore entities associated with source data (e.g., tables) received from connected data sources. In some cases, users may add subtype-supertype annotations to entities to describe relationships between entities. In some cases, the use case catalog facility may include a use case catalog that may be displayed via the graphical user interface. Using the use case catalog, users of the feature engineering control platform may find and explore use cases generated as described herein.

In some embodiments, the feature catalog facility may include one or more feature sets available by a feature set catalog. A feature set may include a set of one or more features generated via the feature engineering control platform as described herein. Via the graphical user interface and using the feature catalog facility, users may generate new feature sets, share the generated feature sets with other users, and/or reuse existing feature sets.

In some embodiments, a feature set can include features extracted for multiple entities, which may increase the complexity of serving the features included in the feature set. The feature catalog facility may identify a feature set's primary entities to simplify serving of a feature set's features. The feature catalog may automatically identify primary entities of a feature set based on entity relationships (e.g., parent-child entity relationships). Each entity included in the feature set that has a child entity in the set may be represented by the respective child entity, such that the lowest level entities of the feature set are the primary entities of the feature set. Typically, such identification of primary entities based on entity relationships results in a single primary entity for a feature set and related use cases. In some cases, based on users needing to change the name of columns (referred to as “serving names”) of the feature data when a feature set is served, the original names of the features can be mapped to new serving names. By default, the serving names may be equivalent to the name of the features.

In some embodiments, the feature catalog facility may enable users to identify and select relevant features for particular use cases via the graphical user interface. In some cases, the feature catalog facility may automatically identify entities associated with a use case by searching for and identifying for parent entities of the use case's entities based on entity relationships. As an example, when a use case's primary entity is a credit card transaction, the related entities are likely to be a credit card, customer, and merchant.

In some embodiments, the feature catalog facility may include a feature catalog of features associated with a use case's primary entities and the parent entities of the primary entities. To facilitate searches for features (e.g., features relevant to particular use cases) via the graphical user interface, the feature catalog may include and display features organized based on an automated tagging of a respective theme of each of the features. As described herein, a theme of a feature may be a tuple including a feature's associated entities, the feature's primary table, and the feature's signal type. The feature catalog facility may automatically tag each generated feature with a respective theme and included signal type. A signal type may be automatically assigned to a feature based on the feature's lineage and the ontology of data used to generate the feature. Examples of signal types can include frequency, recency, monetary, diversity, inventory, location, similarity, stability, timing, statistic, and attribute signal types. To facilitate the selection of a particular feature by a user for serving, key information for the feature from the feature catalog may be displayed in the graphical user interface. The key information for the feature may include a readiness level of the feature (referred to as “feature readiness level”), an indication of whether the feature is used in production (e.g., served to artificial intelligence models for generation of production inferences), the feature's theme, the feature's lineage, the feature's importance with respect to a target object, and/or a visualization of the values of the feature distribution materialized with the use case's corresponding observation set that may be manually provided or automatically generated as described with respect to “Exemplary Techniques for Automatic Generation of Observation Sets.”

In some embodiments, the feature catalog facility may include a feature set catalog of feature sets compatible with a use case. An individual feature set may be used directly for a particular use case and/or may be used as a basis for generating a new feature set. To facilitate the selection of a feature set for a use case, key information for the feature set from the feature catalog may be displayed in the graphical user interface. The key information for the feature set may include the status of the feature set, the percentage of features included in the feature set that are ready for production, the percentage of features included in the feature set that are served in production, the count (e.g., number) and set of features included in the feature set, and/or the count and set of entities and/or themes associated with the features included in the feature set. In some cases, themes (e.g., including signal types) that are not associated with features included in the feature set may be determined by the feature catalog facility and may be displayed via the graphical user interface to provide an indication of potential area(s) of improvement for the feature set.

In some embodiments, the feature catalog facility may enable a feature set builder available via the graphical user interface. Features and/or feature sets may be added to the feature set builder via the graphical user interface. The feature set builder may enable a user to add, remove, and modify features included in the feature sets. In some cases, the feature set builder may automatically determine and display statistics on the percentage of features ready for production and the percentage of features served in production. The displayed statistics may provide an indication to users on the readiness level of their selected features and may encourage reuse of features. In some cases, the feature catalog facility may automatically determine and cause display of recommendations for themes of features to include in a feature set. The feature catalog facility may determine themes that are not associated with features included in a feature set and may inform users of the missing themes, thereby enabling users to search for features covering the respective missing themes.

In some embodiments, the execution graph facility may enable generation of one or more execution query graphs via the graphical user interface. An execution query graph may include one or more features that are converted into a graphical representation of intended operations (e.g., data transformations and/or manipulations) directed to source data (e.g., tables). An execution query graph may be representative of steps used to generate a table view and/or a group of features. An execution query graph may capture and store data manipulation intentions and may enable conversion of the data manipulation intentions to different platform-specific instructions (e.g., SQL instructions). A query execution graph may be converted into platform-specific SQL (e.g., SnowSQL or SparkSQL) instructions, where transformations included in the instructions are executed when their values are needed (e.g., only when their values are needed), such as when a preview or a feature materialization request is performed. Additional features of generation of an execution query graph by the execution graph facility are described herein at least in the section titled “Exemplary Techniques for Generating an Execution Graph.”

### Feature Jobs and Serving

In some embodiments, facilities of the feature engineering control platform corresponding to feature jobs and serving may include feature store and feature job orchestration facilities. In some cases, a feature store facility may be stored and may operate in a client's data platform (e.g., cloud data platform). The feature store facility may include an online feature store and an offline feature store that are automatically managed by the feature store facility to reduce latencies of feature serving at training and inference time (e.g., for artificial intelligence model(s) connected to the feature engineering control platform). In some cases, orchestration of the feature materialization in the online and/or offline feature stores may be automatically triggered by the feature job orchestration facility based on a feature being deployed according to a feature job setting for the feature. Materialization (e.g., computation) of features may be performed in the client's data platform and may be based on metadata received from the platform provider control plane.

In some embodiments, the feature store facility may compute and store partial aggregations of features referred to as “tiles.” Use of tiles may reduce and optimize the amount of resources used to serve historical and online requests for features. The feature store facility may perform computation of features using incremental windows corresponding to tiles (e.g., in place of an entire window of time corresponding to a feature). In some cases, tiles generated by the feature store facility may include offline tiles and online tiles. Online tiles may correspond to deployed features and may be stored in the online feature store. Offline tiles may correspond to both deployed and non-deployed features and may be stored in the offline feature store. If a feature is not deployed, offline tiles corresponding to the feature may be generated and cached based on reception of a historical feature request at the feature store facility. Caching the offline tiles may reduce the latency of responding to subsequent historical feature requests. Based on deployment of a feature, offline tiles may be computed and stored at a same schedule as online tiles based on feature job settings of the feature job orchestration facility.

In some embodiments, use of tiles by the feature store facility may optimize and reduce storage relative to storage of offline features. Optimization and reduction of storage may be based on tiles being: (1) sparser than features; and (2) shared by features computed using the same input columns and aggregation functions, but using different time windows or post aggregations transforms. In some cases, based on online tiles being potentially exposed to incomplete source data received from connected data sources, the feature store facility may recompute the online tiles at execution of each feature job and may automatically fix inconsistencies in the online tiles. The feature store facility may compute offline tiles when a risk of incomplete data impacting computation of the offline tiles is determined to be negligible.

In some embodiments, the feature job orchestration facility may control and implement feature job scheduling to cause the feature store facility to compute and generate features based on tiles stored by the feature store facility. The feature store facility may exclude the most recent source data received from the connected data sources when computing online features (e.g., based on online tiles). A duration between a timestamp corresponding to computation of a feature and a latest event timestamp corresponding to the event data used to compute the feature may be referred to as a blind spot as described herein. Each feature of the feature engineering control platform may be associated with one or more feature versions. Each feature version may include metadata indicative of feature job scheduling for the feature and a blind spot corresponding to computation of the feature. The metadata indicative of feature job scheduling may be added to a feature automatically during the feature declaration or manually when a new feature version is created.

In some embodiments, the feature job orchestration facility may automatically analyze the record creation (e.g., a frequency of record creation) of data sources (e.g., source tables) for event data. The feature job orchestration facility may analyze record creation for event data based on annotated record creation timestamps added to event data by a user. Analysis of record creation of data sources (e.g., source tables) for event data may include identification of data availability and data freshness for the event data based on timestamps associated with rows of the event data, record creation timestamps added to event data, and/or a rate at which the event data is received and/or updated from the data source. Based on analysis of record creation for event data, the feature job orchestration facility may automatically recommend a default setting for the feature job scheduling and/or the blind spot duration for the event data (e.g., event table). The default setting may include a selected frequency for feature job execution to compute a particular feature and a selected duration for a blind spot between a timestamp at which a feature is computed and a latest event timestamp of the event data used to compute the feature. In some cases, an alternative feature job setting may be selected by a user in connection with the declaration of the event table or feature. A user may select an alternative feature job setting when the user desires a more conservative (e.g., increased) blind spot parameter and/or a less frequent feature job schedule. Additional descriptions of automated feature job scheduling are described herein at least in the section titled “Exemplary Techniques for Automated Feature Job Setting.”

In some embodiments, the feature store facility may serve computed features (referred to as “feature serving”) based on receiving feature requests. A feature request may be manually triggered by the user or may originate from an external computing system that is communicatively connected to the feature engineering control platform. Examples of the external computing systems can include computing systems associated with artificial intelligence models that may perform training activities and generate predictions based on features received from the feature engineering control platform. Feature requests may include historical requests and online requests. In some cases, serving of historical features (referred to as “historical feature serving”) based on historical requests can occur any time after declaration of a feature set. Historical requests may typically be made for EDA, training, retraining, and/or testing purposes.

In some embodiments, a historical request should include an observation set that specifies historical values of a feature set's entities (e.g., primary entities) at respective historical points in time (e.g., corresponding to timestamps). In some cases, a historical request may include the context and/or the use case for which the historical request is made. When a feature set served in response to a historical request includes one or more on-demand features, the historical request may include indication of information needed to compute the on-demand features. A feature served in response to a historical request is materialized using information available at the historical points-in-time indicated by the historical request (e.g., without using information unavailable at that historical point-in-time). For example, a feature served for a historical request may be materialized based on source data available before and/or at the historical points-in-time of the historical request.

In some embodiments, when a use case is formulated mathematically with a context view and an expected inference time, observation set(s) designed for the use case may be automatically generated by the declarative framework facility as described herein. For the declarative framework facility to automatically generate the observation set(s), a user may provide a use case name and/or a context name; start and end timestamps to define the time period of the observation set; the maximum desired size of the observation set; a randomization seed; and/or for a context for which the entity is not an event entity, the desired minimum time interval between two observations of the same entity instance. The default value of the desired minimum time interval may be equal to the target object's horizon if known.

In some embodiments, the feature engineering control platform may prompt the user to provide the above-described information. When a use case has a defined target recipe, the target object may be automatically included in the observation set. Observation sets automatically generated as described herein may be used for EDA, training, re-training, and/or testing of artificial intelligence models. Additional descriptions of automatic generation of observation sets are described herein at least in the section titled “Exemplary Techniques for Automatic Generation of Observation Sets.”

In some embodiments, serving of online features (referred to as “online feature serving”) based on online requests can occur any time after declaration and deployment of a feature set. A feature set may be deployed without use of separate pipelines and/or tools external to the feature engineering control platform. A feature set may be deployed via the graphical user interface or the SDK of the feature engineering control platform. Orchestration of feature materialization into the online feature store is automatically triggered by feature job scheduling. Online features may be served in response to online requests via a REST API service.

In some embodiments, an online request may include an instance of a feature set's entities (e.g., primary entities) for which an inference is needed. In some cases, an online request may include the context and/or the use case for which the online request is made. For the inference of contexts with an event entity, an online request may include an instance of the entities attributes that are not available yet at inference time. When a feature set served in response to an online request includes one or more on-demand features, the online request may include indication of information needed to compute the on-demand features.

In some embodiments, deployment of a feature set may be disabled any time via the feature engineering control platform. Deployment of a feature set may be disabled when online serving of the feature set is not needed (e.g., by an external computing system). Contrary to a log and wait approach, disabling the deployment of a feature by the feature engineering control platform does not affect the serving of received historical requests.

### Feature Management

In some embodiments, facilities of the feature engineering control platform corresponding to feature management may include feature governance, feature observability, feature set deployment, and use case management facilities. In some cases, a feature governance facility may enable governance and control of versions of features and feature sets generated by the feature engineering control platform. The feature governance facility may automatically generate new versions of features and feature sets and may track each version of a feature and feature set generated as described herein. The feature governance facility may automatically generate new versions of features when new data quality issues arise and/or when changes occur to the management of source data corresponding to a feature. The feature governance facility may generate a new version of a feature without disruption to the serving of the deployed version of the feature and/or a feature set including the deployed version of the feature.

In some embodiments, each version of a feature (referred to as a “feature version”) may have a feature lineage. A feature lineage may include first computer code (e.g., SDK code) that can be used to declare a version of a feature and second computer code (e.g., SQL code) that can be used to compute a value for the version of the feature from source data. A feature lineage for a feature version may enable auditing of the feature version (e.g., prior to deployment of the feature) and derivation of features similar to the feature version in the future. In some cases, each version of a feature and/or a feature set may include a readiness level or status indicative of whether the respective feature and/or feature set is ready for deployment and production operation.

In some embodiments, support of versioning for features may mitigate and manage undesirable changes in the management or the data quality of source data received from data sources. When changes occur to the management of the data sources (e.g., source tables), the feature governance facility may enable (1) selection of a new default schedule for a feature job setting at the table level and (2) generation of a new version of a feature based on the new feature job setting. When changes occur to the data quality of the data sources (e.g., source tables), feature governance facility may enable annotation of new default cleaning steps to columns of the table that are affected by the changes and facilitation of generating new feature versions for features that use the affected columns as an input for feature computation. When a new version of a feature is generated, the feature engineering control platform may continue to serve older versions of the feature in response to historical and/or online requests (e.g., to not disrupt the inference of artificial intelligence operations tasks that rely on the feature).

In some embodiments, with respect to changes to data quality annotation when a column of a table is not used by a feature, data quality information associated with the column can be updated without disruption to feature serving. When a column of a table is used by a feature, users may (1) formulate a plan to including an indication of how a change to the column may impact the feature versions; and (2) submit the plan for approval before making changes to data quality annotation for the column. The plan may indicate any variations to cleaning settings, and whether to override current feature versions, create new feature versions, or perform no action. From the plan and via the graphical user interface, users may receive indications of feature versions that have inappropriate data cleaning settings and feature set versions including the respective feature versions that have inappropriate data cleaning settings.

In some embodiments, with respect to changes to data quality annotation when a column of a table is used by a feature, the feature engineering control platform may recommend generating new feature versions in place of overwriting current feature versions. To aid evaluation of the impact of changes to data quality annotation, users can materialize the affected features before and after the changes by selecting an observation set for materialization of the features. Based on definition of new data quality annotation (e.g., cleaning step) settings for each affected feature version, a user may submit the plan via the graphical user interface. Based on approval of the plan (e.g., via an administrator or another individual accessing the feature engineering control platform), the changes included in the plan may be applied to the table to cause generation of new feature versions. When an option of a new feature version generation is selected in the plan, the new feature version inherits the readiness level of the older feature version and the older feature version is automatically deprecated. When the old feature version is the default version of the feature, the new feature version may automatically become the default version.

In some embodiments, the feature governance facility may support one or more modes for feature set versioning. In some cases, a first mode of the one or more modes may be an automatic mode. Based on a feature set having an automatic mode for versioning, the feature governance facility may cause automatic generation of new version of the feature set based on changes in version of feature(s) included in the feature set. A new default version of the feature set may then use the current default versions of the features included in the feature set. In some cases, a second mode of the one or more modes may be a manual mode. Based on a feature set having a manual mode for versioning, users may manually generate a new version of a feature set and new versions of a feature set may not be automatically generated. The feature versions that are specified by a user may be changed in the new feature set version relative to an original feature set version (e.g., without changing the feature versions of other features). Feature versions that are not specified by a user may remain the same as the original feature set version. In some cases, a third mode of the one or more modes may be a semi-automatic mode. Based on a feature set having a semi-automatic mode for versioning, the default version of the feature set may include current default versions of features except for feature versions that are specified by a user.

In some embodiments, each feature version may have a respective feature lineage including include first computer code (e.g., SDK code) that can be used to declare a version of a feature and second computer code (e.g., SQL code) that can be used to compute a value for the version of the feature from source data. The first computer code may be displayed via the graphical user interface based on selection of a feature version's feature lineage. In some cases, the displayed first code (e.g., SDK code) is pruned to display only steps related to the feature and automatically organized based on key steps (e.g., key steps such as joins, column derivations, aggregation, and post aggregation transforms).

In some embodiments, the feature governance facility may determine and associate a feature readiness level with each feature version. The feature governance facility may support one or more feature readiness levels and may automatically determine a feature readiness level for a feature version. A first level of the one or more feature readiness levels may be a production ready level that indicates that a feature version is ready for production. A second level of the one or more feature readiness levels may be a draft level that indicates that a feature version may be shared for training purposes (e.g., only for training purposes). A third level of the one or more feature readiness levels may be a quarantine level that indicates that a feature version has recently experienced issues, may be used with caution, and/or is under review for further evaluation. A fourth level of the one or more feature readiness levels may be a deprecated level that indicates that a feature version is not recommended for use for training and/or online serving. In some cases, the feature governance level may automatically assign the quarantine level to a feature version when issues are raised. The quarantine level may provide an indication (e.g., reminder) to users of a need for remediation actions for the feature including actions to: fix data warehouse jobs, fix data quality issues, and/or generate new feature versions to serve healthier features versions for retraining and/or production purposes. When requests call for a feature without specifying the feature's version, the default version is returned in response to the request. In some cases, a “default version” a feature as referred to herein may be the feature version that has a highest readiness. In some cases, the default version of a feature may be manually specified by a user via the graphical user interface.

In some embodiments, the feature governance facility may determine and associate a respective status for each feature set. The feature governance facility may support one or more feature set statuses and may automatically determine a status for a feature set. A first status of the one or more feature set statuses may be a deployed status that indicates that at least one version of a feature set is deployed. A second status of the one or more feature set statuses may be a template status that indicates that a feature set may be used as a reference (e.g., a safe starting point) to generate additional feature sets. A third status of the one or more feature set statuses may be a public draft status that indicates that a feature set is shared with users to solicit comments and feedback from the users. A fourth status of the one or more feature set statuses may be a draft status that indicates that a feature set may only be accessed by an author of the feature set and is unlikely to be deployed as-is. A feature set having a draft status may be generated by users running experiments for a particular use case. A fifth status of the one or more feature set statuses may be a deprecated status that indicates that a feature set may be outdated and is not recommended for use.

In some embodiments, with respect to feature set statuses, before a feature set may be assigned a template status, a description may be associated with the feature set and each of the features included in the feature set may have a production ready feature level for feature readiness. In some cases, the feature governance facility may automatically assign a deployed status to a feature set when at least one version of the feature set is deployed. When deployment is disabled for each version of a feature set, the feature governance facility may automatically assign a public draft status to the feature set. In some cases, only feature sets having a draft status may be deleted from the feature engineering control platform. In some cases, to inform users on the readiness of a feature set, each feature set may have a respective readiness metric (e.g., readiness percentage, ratio, score, etc.) that indicates the percentage of the feature set's features that have a production ready level. Feature readiness levels and feature set statuses may enable and facilitate development and sharing of features and feature sets in an enterprise environment that uses the feature engineering control platform.

In some embodiments, a feature observability facility may enable consistency monitoring of features and feature sets generated by the feature engineering control platform. The feature observability facility may monitor both training and serving consistency of features derived from event data and item data included in the table and may detect issues (e.g., incorrect feature job settings, late updates to records included in source data, and data warehouse job failures) associated with features, such that the issues may be identified for review and remediation by users of the feature engineering control platform. The feature observability facility may monitor both training and serving consistency (also referred to as “offline and online consistency”) of features that are not served in production. In some cases, the feature observability facility may monitor consistency of features that are based on event data (e.g., an event table) based on the record creation timestamp data (e.g., column data) associated with the event data. The feature observability facility may detect issues with features when the features are and are not served.

In some embodiments, the feature observability facility may monitor event data included in the data warehouse. Monitoring the event data may include comparing the event data used for training and serving of features to evaluate the consistency between the data availability and data freshness of the event table over time. Based on monitoring the event data, the feature observability facility may identify issues with the event table such as: delayed creation of the event records (e.g., rows) included in the event table, delayed ingestion of the event data by the data warehouse (referred to as “delayed warehouse updates”), and failures to record event records in event table (e.g., missing data warehouse updates). Based on identification of issues with the event table, the feature observability facility may provide indications of the identified issues that may be displayed via the graphical user interface for user evaluation. In some cases, based on the monitoring, the feature observability facility may identify changes to table schema (e.g., types of columns) for event data included in the table and may provide an indication of such identified changes via the graphical user interface.

In some embodiments, the feature observability facility may monitor correctness of default feature job settings to determine whether the feature job settings for executing feature jobs (e.g., refresh of the offline and online feature stores) for a feature are appropriate. The feature observability facility may determine whether feature job settings are appropriate by determining whether the event data needed to execute the feature job is available and received as needed from the data source and/or is updated with a frequency that is appropriate for the scheduling of the feature job. As an example, feature job settings for a feature may be inappropriate and may be remediated when the event data used to compute the feature is updated at a frequency less than the frequency of feature job scheduling and/or when the event data is unavailable (e.g., not yet available) for execution of a feature job. The feature observability facility may identify when feature job settings for a feature are inappropriate and may provide a prompt for a new feature job setting via the graphical user interface.

In some embodiments, based on the monitoring, the feature observability facility may identify feature versions that are exposed to offline and online inconsistency and the source(s) (e.g., event data) of the inconsistency. The graphical user interface may provide and display the indications of feature versions that are exposed to offline/online inconsistency and the source(s) of the inconsistency. The feature observability facility may automatically assign a quarantine status to identified feature versions that are exposed to offline/online inconsistency, thereby providing an indication to users using the feature versions of remediation actions for the feature versions as described herein. The graphical user interface may display automatically suggested settings for quarantined feature versions. The feature observability facility may automatically assign a quarantine status to feature sets including the quarantined feature versions. The feature observability facility may automatically generate new versions of feature sets based on the new features versions for the quarantined feature versions. Automatic generation of new feature set versions may prevent users from training artificial intelligence models using unhealthy feature sets.

In some embodiments, for online features, the feature observability facility may monitor a consistency of offline and online tiles. Based on a detection of an inconsistency for a tile, the feature observability facility may automatically fix the inconsistency to reduce a duration of the impact of the inconsistency on serving of a feature corresponding to the tile. In some cases, the feature observability facility may evaluate offline and online consistency of online requests based on a sample of the requests. In some cases, the feature observability facility may determine and provide an indication of a source of an inconsistency for a feature when a record creation timestamp was specified for event data used to generate the feature.

In some embodiments, a feature set deployment facility may enable deployment and retraction of feature sets generated by the feature engineering control platform. A feature set may be deployed to enable serving of features included in the feature set for a number of use cases. Feature sets may be deployed and/or retracted from deployment for a given use case via the graphical user interface of the feature engineering control platform without disrupting the serving of the other use cases.

In some embodiments, a use case management facility may enable management of use cases generated via the feature engineering control platform. The use case management facility may enable request tracking for each use case identification of feature set(s) deployed for each use case. The use case management facility may enable the storage of observation sets used for a use case and provides the observation sets for future historical requests of other feature sets. The use case management facility may cache EDA for features. The use case management facility may report issues escalated by the feature observability facility when the affected features are served for the use case. The use case management facility may enable monitoring of use case accuracy.

### Some Embodiments of Feature Engineering Techniques

### Overview

Described herein are AI-assisted feature engineering systems and methods that use efficient, rigorous, data-driven techniques to identify relevant (e.g., the most relevant) features in the vast space of candidate features for a use case. Such feature engineering systems can automatically suggest features (e.g., existing features from a feature catalogue and/or new features that can be extracted or derived from available data sources) suitable for a specified use case. For each suggested feature, the feature engineering system may generate a relevance score and a relevance explanation (e.g., using a generative model). The model may assess the relevance of a feature to a use case based on a description of the feature (which may be automatically generated by the feature engineering system) and a description of the use case (which may be provided by the user). (In some cases, AI-assisted feature engineering techniques may be referred to herein as “feature ideation techniques,” reflecting the expanded scope of AI-assisted feature engineering techniques relative to prior feature engineering techniques.)

In some scenarios, selecting features that have (or are predicted to have) high relevance to the use case helps ensure that the features used for model development are meaningful and relevant to the use case. Also, generating feature descriptions early in the feature engineering and model development process facilitates identification of any regulatory non-compliance issues (e.g., use of data for purposes that are barred by relevant regulatory frameworks) early in the modeling process, before significant resources have been invested.

In some examples, AI-assisted feature engineering techniques can reduce the dimensionality of the feature space for a use case from a large number of candidate features to a much smaller number of suggested or selected features, which are relevant (e.g., semantically and/or statistically relevant) to the use case. Some examples of AI-assisted feature engineering systems and methods are provided. In some examples, these AI-assisted feature engineering techniques are used to identify candidate features relevant to a use case (including candidate features in a feature catalog, candidate features present within source data, and/or candidate features derivable from source data by applying one or more transformations to the source data). Any suitable type of relevance can be identified, including semantic relevance to the use case, statistical relevance to the target variable of the use case (e.g., correlation with the target variable), etc. In some examples, these AI-assisted feature engineering techniques are used to assess the relevance of the candidate features to the use case, and to add a subset of the candidate features to a feature set for the use case. The features added to the feature set can be used to train a machine learning model for the use case.

### Some Examples of a Feature Engineering System

Referring to FIG. 1, the feature engineering (e.g., AI-assisted feature engineering) techniques disclosed herein may be performed by the feature discovery facility. In some embodiments, the feature discovery facility uses three models to assist with feature ideation: a semantic discovery model, a feature description model, and a semantic relevance model. Some embodiments of these models are described in further detail below.

The semantic discovery model may automatically detect the semantic type of source data (e.g., a column) and tag the column with metadata indicating its semantic type. In some embodiments, the semantic discovery model is a generative model (e.g., an off-the-shelf, commercially available generative AI tool) that detects the semantic type of source data (e.g., a column) when queried with a suitable prompt. A suitable prompt may include the table description, column description, name of the column, examples of values of the column, descriptive statistics of the values of the column (e.g., mean, median, max), and/or the data ontology that defines the semantic types. In some embodiments, the feature discovery facility may tag the source data (e.g., column) with metadata indicating the detected semantic type of the source data.

Detection and tagging of semantic types of source data can facilitate the proper functioning of the feature engineering platform of FIG. 1, because many of the functions performed by the feature engineering platform depend on the semantic types of the source data. For example, the feature catalog facility can automatically tag and annotate features with themes and signal types based on the semantic types of the data sources in the feature's lineage. As another example, the feature discovery facility can perform feature discovery based on the semantic types of the data sources. Thus, for source data not tagged with semantic types, feature discovery functionality may be very limited.

The feature description model may automatically generate a description of a manually created (e.g., user-provided) feature in the feature catalog, and tag the feature with metadata indicating the feature description. In some embodiments, the feature description model is a fine-tuned transformer that generates a feature's description based on its feature definition file and the descriptions of the tables and columns that are used to generate the feature. The transformer may be trained with examples of feature definition files and feature descriptions generated by the feature engineering platform (for features generated by the feature discovery facility). In some embodiments, all features in the feature catalog (even user-provided features) have feature definition files, which specify how the features are generated from source data. In some embodiments, a feature definition file may act as a single source of truth for a feature version. In one embodiment, a feature definition file may be automatically generated when a feature is declared in the SDK and/or a new version of the feature is derived. The feature definition file may use the same syntax as used in the SDK. In some examples, the feature definition file may provide an explicit outline of the intended operations of the feature declaration. For example, these operations may include feature job settings and/or cleaning operations inherited from tables metadata. In some examples, the systems described herein may use the feature definition file as the basis for generating a logical execution graph that is translated into platform-specific SQL for feature materialization.

The semantic relevance model may automatically assess the relevance of a feature to a use case, and generate a feature relevance score (which quantifies the feature's relevance to the use case) and a feature relevance description (which describes the feature's relevance to the use case). In some embodiments, the semantic relevance model is a generative model (e.g., an off-the-shelf, commercially available generative AI tool) that assesses the relevance of feature to a use case when queried with a suitable prompt. A suitable prompt may include the use case description, the descriptions of the tables and columns used to generate the feature (and optionally the column semantic types), and/or the feature description of the feature (and optionally the feature's semantic type).

An example of a feature relevance score and feature relevance explanation provided by the semantic relevance model are provided below:

### Example

### Feature:

CUSTOMER_Consistency_of_item_TtoalCost_across_product_ProductGroups_7d_vs_28d Feature description: Consistency score of the customer measured by the Cosine Similarity between the Distribution of total item TotalCost across different product ProductGroups for both the 7d and 28d periods.
Feature relevance score: 8
Feature relevance score explanation: The feature
‘CUSTOMER_Consistency_of_item_TtoalCost_across_product_ProductGroups_7d_vs_28d’ is likely to be quite relevant for predicting a customer's total grocery spending in the next two weeks. This feature measures the consistency of a customer's spending across different product groups of a 7-day and 28-day period. If a customer's spending habits are consistent, it can be easier to predict their future spending. For example, if a customer consistently spends a large portion of their grocery budget on fresh product, it's likely they will continue to do so in the future. Conversely, if a customer's spending habits are erratic or change frequently, it may be more difficult to accurately predict their future spending. Therefore, this feature could be a good indicator of a customer's future spending habits and is likely to be quite relevant for this prediction task.

### Some Examples of an AI-Assisted Feature Engineering Method

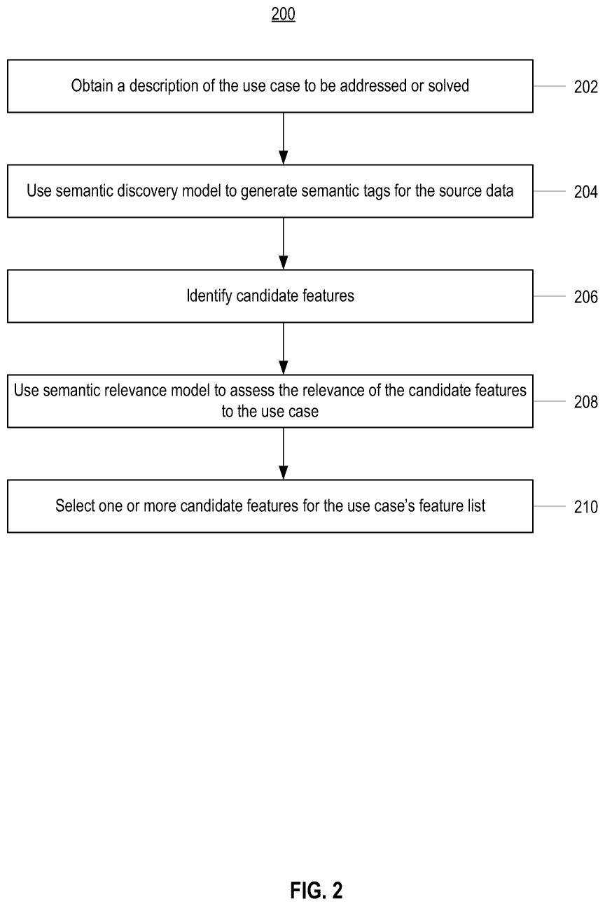

Referring to FIG. 2, a feature engineering (e.g., AI-assisted feature engineering) method 200 may include steps 202-210. In some embodiments, the feature engineering method 200 is performed by the feature discovery facility of a feature engineering platform.

In step 202 of the feature engineering method 200, the feature discovery facility obtains a description of the use case to be addressed or solved. The use case description may be provided by the user. The use case description may include a description of the context (e.g., new customers, active customers, credit card transactions at the moment of the transaction, employee after one year in the company), a target to be predicted (e.g., fraud, new purchase, resignation), and/or a target horizon (e.g., next 2 weeks, next 6 months, etc.). The use case description may include descriptions of tables and/or columns accessible in the data warehouse or provided by the user. In some cases, the user may specify tables/columns expected to be relevant to the use case. In some cases, the context description identifies one or more entities corresponding to the use case.

In step 204 of the feature engineering method 200, the semantic discovery model generates semantic tags for the source data (e.g., columns) in accordance with the data ontology. In some embodiments, users can review and accept or adjust the proposed semantic tags. In some embodiments, a data cleaning model is used to detect anomalies in the source data before generating semantic tags for the source data. The data cleaning model may be a generative model. The data cleaning model may detect anomalies in the source data based on the descriptions of the source data (e.g., columns). When anomalies are detected, the data cleaning model can suggest cleaning operations.

In step 206 of the feature engineering method 200, the feature discovery facility identifies candidate features using a candidate feature discovery process. The candidate feature discovery process may include a step of identifying tables in the feature catalog suitable for the use case. In some embodiments, the use case identifies corresponding entities (or entity types), the tables are tagged with corresponding entities (or entity types), and the feature discovery facility identifies the tables suitable for the use case by searching for any tables tagged with the entities (or any entity types) identified by the use case.

The candidate feature discovery process may include a step of determining how the identified tables can be joined. Table-joining options may be identified based on the type of table (e.g., event table, item table, slowly changing dimension table, dimension table) and the entities represented in the table. The foreign key in the left table may be the key representing the entity that identifies the right table (or the subtype of this entity).

The candidate feature discovery process may include a step of identifying entities E for which suitable features can be generated. The entities E may be identified based on their relationships with the use case entity. For example, suitable features for a recommendation use case include features for the tuple (customer, product) and features for the customer, product, and potentially features for more entities that are parents of the customer, product or its tuple. In some cases, entities that are parent or grand-parents of the use case entity are selected. In some cases, item entities (and their parents or grand-parents) associated with any selected event entities are also selected. In some cases, supertype entities of any selected entities are also selected.

In some embodiments, the child-parent relationship between entities is determined automatically when two entities are represented in the same table and one of them is the primary key of the table (or natural key for a slowly changing dimension table). In some embodiments, the subtype-supertype relationship may be designated by the user.

The candidate feature discovery process may include a step of generating candidate features for the entities E. The candidate features may be generated using any suitable heuristics or rules. In some embodiments, these heuristics or rules codify best practices in feature engineering. In some embodiments, the feature generation techniques applied for a given entity E are selected based on the types of the tables corresponding to the entity, the semantic type of the entity, the relationship(s) of the entity with other entities, and the semantic types of the columns in the tables corresponding to the entity.

At step 208 of the feature engineering method 200, the feature discovery facility assesses the relevance of the candidate features to the use case. For each candidate feature, the feature discovery facility may (i) obtain a feature description and (ii) generate a relevance score and a relevance explanation. These sub-steps are further described below.

The feature description for a candidate feature may be user-provided or automatically generated by the feature discovery facility based on the feature definition files. If the candidate feature is suggested by the feature discovery facility and is a duplicate of an existing feature in the feature catalog, and the existing feature already has a feature description (e.g., user-provided or automatically generated), the existing description of the existing feature may be used. If the candidate feature is suggested by the feature discovery facility and is a duplicate of an existing feature in the feature catalog, and the existing feature has no feature description, the feature discovery facility may generate a feature description for the candidate feature using any suitable heuristics or rules. If the candidate feature is suggested by the feature discovery facility and is not a duplicate of an existing feature in the feature catalog, the feature discovery facility may generate a feature description for the candidate feature using any suitable heuristics or rules. If the candidate feature is not suggested by the feature discovery facility, then the feature is an existing feature in the feature catalog. In this case, if the existing feature has a feature description, the existing feature description may be used. Otherwise, the feature description may be generated using the feature description model.

In some embodiments, the quality of the feature description is tested by assessing whether the description is well understood by a generative model. In some embodiments, the quality of the feature description is rated by the user (e.g., a numerical score, a binary indication of quality such as ‘thumbs up/thumbs down’ or ‘like/dislike’), and that feedback can be used to train the feature description model.

The relevance score and relevance explanation for a candidate feature may be generated by the semantic relevance model. In some embodiments, the semantic relevance model generates the relevance score and relevance explanation based on the use case description and the feature description.

At step 210 of the feature engineering method 200, the feature discovery facility selects one or more of the suggested features for the use case's feature set. This selection can be automatic (e.g., the feature discovery facility selects the N most relevant features), manual (e.g., user input identifies the selected features), or hybrid (e.g., the user reviews a feature set selected by the feature discovery facility and confirms that set or makes adjustments). In some embodiments, users can select all or a subset of the suggested features and create the new suggested features and a new feature set based on the selection. In some embodiments, the feature discovery facility may provide a low code experience whereby the user obtains the features and feature set via a Python notebook SDK. In some embodiments, the feature discovery facility may provide a no code experience whereby the feature engineering platform generates the new features and feature set without exposing any code to the user.

The feature discovery facility may support one or more user interactions in connection with the feature engineering method 200. In some embodiments, the relevance scores and relevance explanations of the candidate features (or selected features) are presented to the user. In some embodiments, the feature discovery facility provides the user with automatically-generated SDK code suitable for generating the candidate features (or selected features). In some embodiments, the feature discovery facility automatically generates a candidate feature (or selected feature) and allows the user to view the feature's lineage, run exploratory data analysis on the feature, view the correlation between the use case target and the feature, etc.

### Some Further Examples of Feature Engineering Systems and Methods

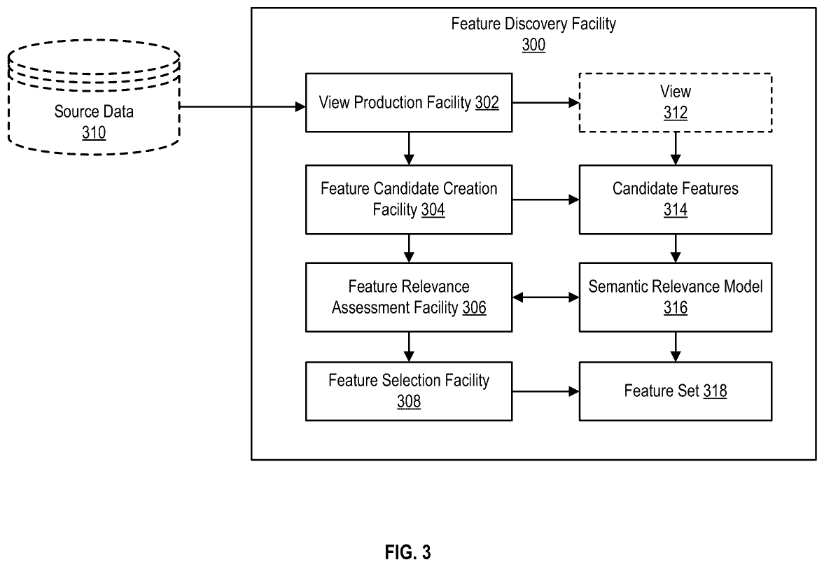

In some embodiments, as illustrated in FIG. 3, a feature engineering system may include a feature discovery facility 300 (e.g., of a platform provider entity control plane as illustrated in FIG. 1). In some embodiments, feature discovery facility 300 may include a view production facility 302 configured to produce one or more views 312 from source data 310. The view production facility 302 may produce the view(s) based on a description of a use case and metadata describing the source data. Some non-limiting embodiments of techniques for producing view(s) relevant to a use case from source data 310 are described herein. In some embodiments, the view production facility 302 includes a feature engineering model (e.g., a generative model), which the view production facility 302 uses to produce the view(s) 312. Some non-limiting embodiments of the feature engineering model are described herein. In one embodiment, source data 310 may be hosted on a separate server from feature discovery facility 300. For example, source data 310 may be hosted on a server operated or controlled by a user and feature discovery facility 300 may be hosted on a server operated or controlled by a provider of feature engineering services. In some embodiments, view(s) 312 may be created by feature discovery facility 300 (e.g., in response to instructions or commands issued by feature discovery facility 300) but may be stored on a server remote from feature discovery facility 300, such as the server that hosts source data 310.

In some examples, a feature candidate creation facility 304 is configured to create one or more candidate features 314 based on the view(s) 312 of source data 310. Some non-limiting techniques for creating candidate features for a use case based on one or more view(s) 312 are described herein. A feature relevance assessment facility 306 may prompt a semantic relevance model 316 (e.g., a generative model) to assess the relevance of candidate features 314. Some non-limiting embodiments of a semantic relevance model are described herein. Based at least in part on this assessment, a feature selection facility 308 may produce a feature set 318. For example, feature selection facility 308 may select the features identified as relevant by feature relevance assessment facility 306 for inclusion in feature set 318 (e.g., features with a relevance score above a predetermined threshold, a fixed number of features ranked as most relevant, a fixed percentage of features ranked as most relevant, etc.).

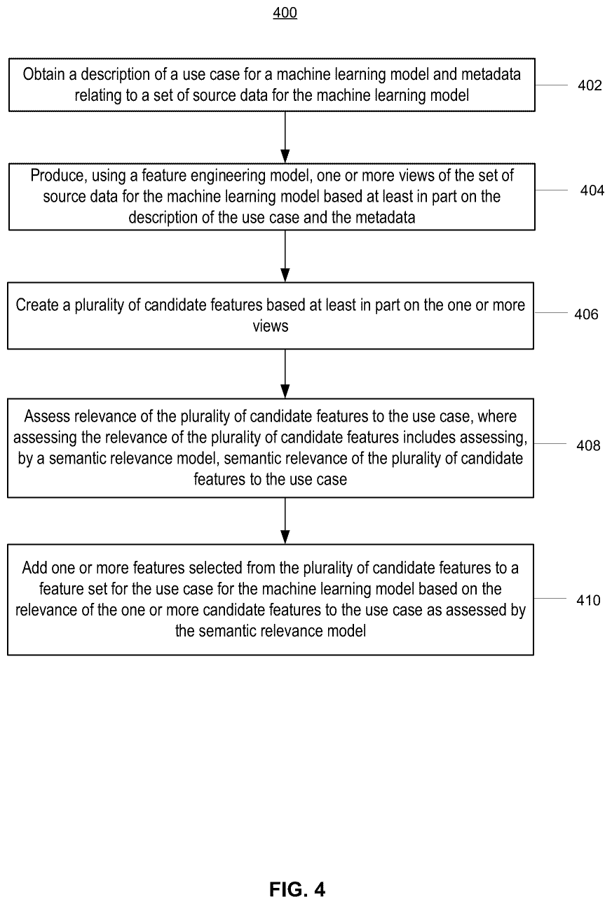

FIG. 4 is a flow diagram of an example feature engineering method 400 (e.g., an AI-assisted feature engineering method). For example, at step 402, the systems described herein may obtain a description of a use case for a machine learning model and metadata relating to a set of source data for the machine learning model. The machine learning model may be any suitable type of machine learning model. The metadata may describe various aspects of the source data such as number and/or names of tables, rows, columns, entities, etc., within the source data.

At step 404, the systems described herein may produce, using a feature engineering model, one or more views of the set of source data for the machine learning model based at least in part on the description of the use case and the metadata. In some embodiments, the feature engineering model may include a generative model. For example, the feature engineering model may include an LLM and a set of customized prompts that, when provided to the LLM as input along with the metadata about the source data, cause the LLM to output one or more views derived from the source data. In some embodiments, the generative model may be a commercial off-the-shelf LLM, while in other embodiments, the generative model may be a fine-tuned LLM trained to create feature engineering plans.

At step 406, the systems described herein may create candidate features based at least in part on the one or more views. The term “candidate feature,” as used herein, may refer to a feature recipe that can be executed to produce an observation set for a feature (e.g., from source data 310). The produced observation set for the feature may be provided as input to a machine learning algorithm or model. In some examples, a candidate feature may be a candidate for inclusion in a set of features and/or feature recipes corresponding to a use case.

At step 408, the systems described herein may assess relevance of the candidate features to the use case. Assessing the relevance of the candidate features may include assessing, by a semantic relevance model, semantic relevance of the candidate features to the use case. In some embodiments, the semantic relevance model may include a generative model, such as an LLM. In some embodiments, the generative model may be a commercial off-the-shelf LLM, while in other embodiments, the generative model may be a fine-tuned LLM trained to assess the relevance of candidate features to use cases. In some embodiments, the systems described herein may prompt the generative model to assess the semantic relevance of a candidate feature (e.g., to a use case) using a prompt selected from a library of custom prompts. In some embodiments, assessing the relevance of the candidate features may include assessing the statistical relevance of the candidate features to the target variable of the use case (e.g., the correlation between values of the candidate features and the values of the target variable).

At step 410, the systems described herein may add one or more features selected from the group of candidate features to a feature set for the use case (e.g., for training the machine learning model) based on the relevance of the one or more candidate features to the use case (e.g., the semantic relevance as assessed by the semantic relevance model). In some embodiments, the systems described herein may provide observation sets for the features in the feature set as training data or inference data for the machine learning model associated with the use case. Additionally, or alternatively, the systems described herein may present the feature set to a user for approval before generating training or inference data based on the feature set. In some embodiments, the systems described herein may create an explanation of the features via a generative model such as an LLM and may present this explanation to the user alongside the set of features.

### Some Further Examples of Feature Engineering Techniques

In some embodiments, a feature discovery facility 300 of a feature engineering system may be configured to identify, describe, evaluate (e.g., assess) candidate features and to suggest feature sets for machine learning. In some embodiments, a feature engineering control platform may be configured to provide source code that can be executed to produce observation sets for features for specific use cases and machine learning models. In some examples, the feature discovery facility utilizes a hybrid approach that merges rule-based principles of best practices in feature engineering with generative models (or AI agents incorporating generative models). Such generative models may examine metadata associated with source data to provide recommendations regarding selection of feature candidates; these recommendations can be adopted automatically or subject to user review and adjustments. The agentic system can operate autonomously end-to-end or with the human in the loop.

In one embodiment, the feature discovery facility collects use case information. For example, the facility may collect one or more (e.g., all) of the following types of use case information: use case description data describing the context and objectives linked to the use case; context data describing the environment and conditions in which the features will be used; target data identifying the target that the model is trained to predict; target horizon data (if applicable) specifying the prediction time frame; target forecast point data (if applicable) indicating a forecast date or timestamp for inference data; and observation table data including historical data points forming the basis for learning. The observation table may reflect the real-world conditions and scenarios in which the features are to be applied. This table can be generated automatically based on the use case formulation or provided by the user.

In some embodiments, the feature discovery facility gathers model data information. For example, the facility may gather table metadata that provides descriptions, types, tagged entities, default settings, columns, data types, semantics, default feature job settings, and/or default cleaning operations associated with each table. Additionally or alternatively, the facility may gather entities metadata that indicates which entities are represented in the tables and their roles (primary/alternate key, foreign key, etc.) and/or also outlines how entities are related (e.g., interconnected).

In some embodiments, the view production facility 302 may evaluate cleaning options. For example, the facility may assesses the effectiveness of existing default cleaning operations and propose new cleaning operations if the current operations are not adequate.

In some examples, the view production facility 302 may identify missing semantics mapping(s) in the source data 310. For example, the facility may utilize a generative model (e.g., semantic discovery model) to analyze table and column metadata for the source data and propose semantic tags for columns that currently lack them. These tags may describe the semantics of the columns based on a feature engineering data ontology (e.g., a data ontology as described herein). In some examples, the view production facility may use a generative model (e.g., semantic discover model) to propose aliases for column names. These aliases may be used to identify operations (such as transforms and filters) and features that utilize those columns.

In some embodiments, the feature discovery facility 300 may include a feature engineering model (e.g., a generative model such as an LLM), which the view production facility 302 may use to develop a feature engineering plan. This model may develop the feature engineering plan by analyzing the frequency of the events for transaction tables, identifying key entities and columns relevant to the use case, analyzing table relationships for potential enrichments (e.g., transformations, filters, etc.), and/or devising tailored filtering strategies for event and item tables. The model may also address handling ambiguous data, suggesting arithmetic operations for creating meaningful new columns, and/or propose the integration of custom functions on specific columns. Additionally, the model may select appropriate time windows based on the specifics of the use case. In some examples, if event entities of transaction tables (e.g., event and item tables) are also associated with slowing changing dimension tables tracking the event status (such as fraud status), the model may tailor filtering strategies for those events.

In some embodiments, the view production facility 302 may collect statistics. For example, the algorithm may collect column statistics for columns of data in source data tables and/or in views by accumulating statistical metrics for each column (e.g., after filtering and cleaning processes). Column statistics may include the number of unique values and missing values, the minimum and maximum values within each column, etc. In some examples, the view production facility 302 also evaluates changes in semantics after filtering. For example, a column with only one unique value may be marked as having non-informative semantics, as the column's values don't contribute variance or distinction to the dataset. In another example, minimum and maximum values may be assessed to ascertain the potential change in the sign (positive or negative) of the data in the column, which might occur due to filtering or cleaning actions. If the original semantic value was bounded_amount, the filtered semantic value may be adjusted to non_negative_amount or non_positive_amount. In one embodiment, the systems described herein may evaluate foreign key entities' fixed attributes by pinpointing columns in a table that represent fixed attributes associated with each entity represented by a foreign key.

In some embodiments, the view production facility 302 may create and enhance views by implementing a feature engineering plan. This plan may enrich views associated with the use case by applying transformations, joining views, integrating spatial and temporal data, and/or applying specific filters. The view production facility 302 may assemble information about the views and/or output code for creating views and outputs associated with each code block.

In some embodiments, the feature candidate creation facility 304 may identify and/or create candidate features via a process that leverages the view(s) 312 generated by the view production facility 302. The process may include, without limitation, one or more of the following steps: capturing entity attributes through lookups; summarizing item data per event; aggregating data over specific time windows; capturing details of the most recent event; deriving stability features comparing different windows; creating similarity features comparing different entities or entity groups; comparing the most recent event with past events; comparing recent items with past items for the same entity; deriving cross features; deriving features with the same seasonality as the forecast point; comparing a specific use case event with past events; comparing use case event items with past items; capturing changes in attributes of entities represented by slowly changing dimension tables; and creating inventories at specific point-in-times. In some embodiments, one or more steps of the process may progressively build on previous steps to enrich the feature set, while in other embodiments, some steps may be omitted and/or performed in a different order. The feature candidate creation facility 304 may output feature information that describes each candidate feature (e.g., the candidate feature's lineage) and/or source code for creating features and outputs associated with each code block. In some embodiments, the feature candidate creation facility 304 may provide one or more templates used to represent graphically a diagram of the feature operation steps and reproduce the feature with a no-code user interface.

In some embodiments, the feature candidate creation facility 304 may name and describe candidate features. For example, for each candidate feature generated by the feature discovery facility 300, the feature candidate creation facility 304 may automatically generate a name and description for the candidate feature that reflect its lineage. To keep the feature name concise, the systems described herein may use suggestions from a generative model for column alias, transforms, and/or filters.

In one embodiment, the feature candidate creation facility 304 may cross-references candidate features with existing features to prevent feature redundancy. Such redundancy checking may include gathering relevant code blocks for each candidate feature, matching the lineage of the candidate features with the code blocks outputs; testing and converting the code into a feature execution plan (e.g., feature recipe); comparing the new feature execution plan to existing feature execution plans in the catalog; and, if a similar feature is found in the catalog, recommending the feature in the catalog rather than the new feature.

In some embodiments, feature candidate creation facility 304 may categorize candidate features based on their feature execution plans. The categories may include, without limitation: primary entity (e.g., the level of analysis of the candidate feature); primary table (e.g., main data source for the candidate feature); and/or signal type (e.g., the nature of the data signals captured by the feature candidate).

In some embodiments, the feature relevance assessment facility 306 may assess the relevance of candidate features (e.g., to a use case). For example, the systems described herein may assess semantic relevance and statistical relevance of candidate features (e.g. to a use case). In some examples, the statistical relevance of a feature candidate indicates the strength of the correlation between values of the feature candidate and values of the use case's target variable. In some examples, statistical relevance is represented by a predictive score. Assessing semantic and statistical relevance can facilitate identification of features that not only exhibit statistical correlation with the target variable but also carry contextual meaning. In some embodiments, the feature relevance assessment facility may use a generative model (e.g., semantic relevance model) to evaluate the candidate feature's semantic relevance to the use case, based on the candidate feature's description, the use case description, table and column metadata (e.g., of the table(s) and/or column(s) from which the candidate feature is derived), transformations and/or filters applied to the source data and/or views to produce the candidate feature. In some examples, the feature relevance assessment facility 306 may determine a candidate feature's statistical relevance to the use case (e.g., to the target of the use case) by materializing features with the provided observation table and utilizing specialized models (e.g., XGBoost, etc.) to assess the statistical relevance numerical, categorical, or dictionary features, utilizing a regularized linear regression model to assess the relevance of textual features, etc. The resulting predictive score (PS) measures the relationship between the feature and the target variable within the context of the specific use case. A PS score of 1 indicates perfect correlation with the target, while 0 suggests no correlation. The feature relevance assessment facility may produce as output a table of candidate features with their relevance scores and explanations.

In one embodiment, the feature selection facility 308 may provide users with a user interface to review feature suggestions (e.g., candidate features recommended for inclusion in the feature set 318 for the use case). In some examples, the user interface displays the feature suggestions in the form of a table of candidate features with candidate feature name, candidate feature description, relevance scores, explanations, primary entity, primary table, signal type, existing status in the feature catalog, and/or any other suitable information. Users can select features (e.g., based on relevance scores, various filtering options, etc.) to integrate them into the catalog directly or download Python notebooks for further customization. In some embodiments, the feature discovery facility may perform automated selection of features (from the pool of candidate features) for a use case using a generative model. The generative model may select one or more features from the pool of feature candidates based on any suitable information, e.g., feature descriptions and/or feature tags. Those selections can be generated from all ideated features or any subset. This approach allows for the production of meaningful feature sets, covering a wide range of signals while reducing redundancy.

### Developing a Feature Engineering Plan

In some embodiments, the feature discovery facility 300 may develop a feature engineering plan. In some examples, this process may entail making decisions that shape the feature engineering approach, utilizing generative AI to propose suggestions which are then subjected to review and refinement by users.

In one embodiment, view production facility 302 may perform entity identification. For example, view production facility 302 may include a generative model that automatically identifies entities for feature creation within the dataset (e.g., the parents of the use case entities) and/or analyzes each entity's link to the use case and its role in the relevant events or items. In some examples, an entity can be a tuple of entities (e.g., for the interaction between credit cardholder and merchant for a use case on credit card transactions, the credit cardholder entity and the merchant entity may collectively be treated as an individual entity). View production facility 302 may output a set of identified entities along with their properties and relevance to the use case.

In some embodiments, view production facility 302 may perform table relationship analysis to find potential enrichments through table joins by scanning through the tables of source data associated with the identified entities. In some embodiments, view production facility 302 identifies slowly changing dimension (SCD) tables tracking the status of events associated with transaction tables (event and item tables). In some examples, view production facility 302 may output, for each event table and item table, a set of tables to join and SCD tables tracking the status of the corresponding events and items.

In some embodiments, view production facility 302 may assesses the frequency of events for each event table relative to the use case entity (e.g., assess the frequency of particular events for particular entities). Based on this event frequency determination, the view production facility can determine the appropriate date part to extract and the types of features to engineer. In one example, view production facility 302 may categorize event frequency as follows: rare events (e.g., infrequent and unpredictable occurrences); seasonal regular events (e.g., regular occurrences tied to specific seasons or periods, happening no more than once per season); frequent events (e.g., common occurrences, happening several times a week but at irregular intervals); very frequent events (e.g., events happening multiple times daily); and/or telemetry events (e.g., high-frequency, regular measurement events).

In one embodiment, view production facility 302 may devise filtering strategies tailored for event tables and their associated item tables. For example, view production facility 302 may include a generative model that may discern event/item types and statuses (e.g., key event/item types and statuses) pertinent to the use case and/or suggest filters along with a relevance score, explanation, and/or a concise name for the filter operations. These filter names may be used to name features derived from them. Additionally, the frequency of the events may be reevaluated after filtering (e.g., by view production facility 302). In some examples, the generative model may evaluate filter compatibility with an entity. The generative model may also identify and flag filters that may be irrelevant or unsuitable for specific entities in the use case by analyzing the observation table data points. For example, in a credit card transaction scenario that focuses on merchants, the generative model may flag irrelevant filters such as credit card fees, as such filters can lead to features for the merchant that contain only missing values. The generative model may output, for each event table and item table, a set of relevant filters for user review. The generative model may output, for each entity identified for feature creation, a set of compatible filters.

In some embodiments, view production facility 302 may include a generative model that offers solutions for managing columns with ambiguous numeric or categorical semantics. For example, when dealing with temperature data recorded in both Fahrenheit and Celsius, the generative model may recommend a standardization process to ensure all measurements are in a consistent unit. In another example, in cases where city names are provided without specifying their associated state or country, the generative model may suggest concatenating the city name with the state to eliminate ambiguity. This enhancement facilitates accurate identification of cities, particularly when identical city names exist in various regions. In some examples, the generative model may output a set of operations used to reduce or eliminate ambiguity for user review.

In one embodiment, the generative model may suggest arithmetic operations such as addition, subtraction, multiplication, or division, as well as time deltas, date parts, distances, or string operations, for creating new meaningful columns. The generative model may also identify the semantic of the new columns, suggest names, assess relevance to the use case, and/or evaluate redundancy with existing columns. In some examples, the generative model may output a set of operations used to create the new columns, along with their semantics, for user review.

In some embodiments, the generative model may, in response to a prompt provided by view production facility 302, propose the application of custom functions on columns, based on their semantics. For example, the generative model may suggest using LLMs for text or description columns to convert them into embedding vectors. The generative model may output a set of User-Defined Functions (UDFs) with their corresponding columns, along with the data type and semantics of their output, for user review.

In some examples, the generative model may, in response to a prompt provided by view production facility 302, identify the Key Numeric Aggregation Column for each table. This numeric column generally represents counts, monetary amounts, or durations. In some examples, view production facility 302 may use this column to build more advanced aggregated features such as sums across grouped categories defined by categorical columns that may be useful for uncovering patterns and trends within data subgroups. Features from these aggregations can be directly applied or further analyzed to evaluate diversity, assess stability, or identify key categories, providing deeper insights into distributions than features relying solely on counts.

For example, if there is a dataset containing credit card transactions with columns such as Card ID, Merchant Type, and Amount, by using the “Amount” column as the Aggregation Metric, the generative model can create a feature that aggregates the total transaction amount for each Merchant Type, per card, and then create a feature that measures the diversity of expenses across Merchant Type.

In some embodiments, view production facility 302 may analyze and select appropriate time windows based on the use case specifics. For example, a generative model may recommend time windows, with shorter windows for immediate-term predictions and longer windows for extended-term forecasts and/or may assess whether the window size is compatible with the feature job setting of each table. For tables with a seasonal frequency, the view production facility 302 may adapt the window unit to the season (e.g., week, month).

### Generating and Enhancing Views

In some embodiments, the view production facility 302 generates (e.g., creates) and enhances (e.g., refines) data views based on the source data. In some examples, generating and enhancing the views involves implementing the feature engineering plan, leading to the creation of a set of metadata for these views and the corresponding code that can be executed to generate them.

In some embodiments, the view production facility 302 may generate table views. For example, view production facility 302 may create views of data tables and gather information about these tables, such as their type, what they represent (table entity), the frequency of the events for the use case entity, what columns they have, and/or how data in these tables can be grouped (aggregation windows). Sometimes, tables are linked (e.g., item tables and event tables). In these cases, the view production facility 302 may combine information from these related tables.

In some examples, the view production facility 302 may enrich these views with more context (e.g., semantic levels or labels derived from the data ontology and information regarding related entities). Additionally, or alternatively, view production facility 302 may clean and/or create new columns following the feature engineering plan. For example, view production facility 302 may implement new data cleaning operations and/or create new columns that provide clearer or additional insights. In some examples, view production facility 302 may employ User-Defined Functions (UDFs) for specialized calculations beyond standard functions. UDFs, which can include or invoke models (e.g., generative models) can be particularly useful for advanced calculations. The view production facility 302 may update the metadata for each new column, including its data type, semantics, and origin. If a column is linked to an entity, this connection can be maintained in the new column's metadata.

In some examples, view production facility 302 may combine various views as planned and update their metadata with new information from the merged columns. In one example, view production facility 302 may detect columns with geographic data (e.g., latitude and longitude) and calculate distances between entities based on these coordinates (e.g., using the haversine formula) and categorize these distances. In some examples, view production facility 302 may perform calculations selectively, using data that indicates physical presence.

Similarly, view production facility 302 may identify key date-time columns in each view, extract specific date parts (e.g., hour or day of the week) in function of the frequency of the events and create new columns for them, generate additional date-related features (e.g., features identifying weekends or specific times in a week), and/or calculate age from date of birth data and categorize it.

In some examples, view production facility 302 may identify columns in the data that have circular semantics. This could include data like time of day, compass directions, months of the year, or angles in degrees or radians. For each identified circular data column, view production facility 302 may create two new columns representing the cosine and sine values of the original data.

In some embodiments, view production facility 302 may apply filters to views based on specific event or item attributes, like type or status, as outlined in the feature engineering plan, and/or update the descriptions and semantic details for each filtered view.

In some examples, for each event table and item table associated with a SCD table that tracks event status changes, view production facility 302 may create a new table for each status. This new table may include the status change timestamp and the join columns from the event table. This new table can then be utilized as an event table.

Additionally, or alternatively, view production facility 302 may create Inter-Event Time (IET) and Distance Columns. For linked entities, the view production facility 302 may calculate the time between two successive events (IET) to analyze patterns like binge-watching. For moving objects, view production facility 302 may calculate the distance between events and create columns for travel time, speed, and acceleration, filtering out instances with no distance data.

### Creating Features

In some embodiments, feature candidate creation facility 304 creates candidate features (e.g., identifies candidate features, creates feature recipes for candidate features, etc.) based on the views of the source data and/or based on existing features (e.g., by transforming the existing features). Some steps of the feature creation process progressively build on the previous steps to enrich the feature set. The end result can include a set of metadata for these candidate features and the code that can be executed to generate them.

In some examples, feature candidate creation facility 304 may capture entity attributes through lookups while focusing on tables that represent an entity identified as relevant for feature creation in the feature engineering plan. In one embodiment, feature candidate creation facility 304 may iterate through columns in these tables and creates a lookup feature for each column, provided it meets the following criteria: the column was not added through joins and the column semantics are not within a specified set of semantic categories (e.g., ‘non_informative’, ‘unique_identifier,’ ‘ambiguous_categorical,’ ‘ambiguous_numeric,’ ‘converter,’ ‘person_name,’ ‘street_address’, ‘lag’, ‘date_time’, etc.). If a column is categorized as a specific ‘date_time’ (e.g., ‘start_date’), a feature can be derived to measure the time elapsed since the date specified in that column (e.g., time since customer's onboarding date). For columns with ‘date_of_birth’ semantics, this process may create an age feature. Additionally, the process may generate a new feature that categorizes age into different age bands (e.g., customer age band).

In some examples, feature candidate creation facility 304 may summarize item data per event. For non-filtered item views, feature candidate creation facility 304 may create features that condense information pertaining to individual items within their respective events. Creating such features may involve performing various straightforward aggregations, such as counting, or summing on relevant columns, such as invoice basket size. When categorical columns are present, feature candidate creation facility 304 may conduct cross-aggregations, which generate distributions across different categories. This process is sometimes referred to as ‘binning’ or ‘bucketing.’ The result may be a dictionary. This dictionary can include keys representing the different categories. The values can correspond to the count of items or the sum of the ‘Key Numeric Aggregation Column’ or any other relevant column, often a column containing values such as ‘amount’ and ‘quantity’ (e.g., invoice's items amounts distributed across product group). These newly derived features can then be incorporated into the relevant event views for subsequent analysis. For example, feature candidate creation facility 304 may add a ‘Count of Items’ feature to the view of the Invoice table. This new column can allow feature candidate creation facility 304 to compute in subsequent steps statistics on the history of the size of the customer's shopping baskets.

In some embodiments, feature candidate creation facility 304 may aggregate data per time window by creating features for each event or item view before or after filtering. In one embodiment, feature candidate creation facility 304 may aggregate data within specified time windows, as identified in the feature engineering plan. The aggregations may encompass various statistical operations (e.g., counting, summing, averaging and calculating standard deviation, identifying minimum and/or maximum, etc.). These aggregations may be grouped by entities that are deemed relevant based on the feature engineering plan. For tables where the event frequency is seasonal, feature candidate creation facility 304 may set the window endpoint at the end of the previous season. Feature candidate creation facility 304 may discard columns that are fixed attributes for the entity, as the values of such columns are often unsuitable for aggregation. These columns can represent invariant characteristics of the entity and therefore their aggregation doesn't add value (e.g., lacks relevance to the use case). The choice of aggregation method may be determined based on the semantics of the column to aggregate. Some examples may include, without limitation: credit cardholder's sum of purchase transaction amounts the past 12 weeks; maximum time interval between two cash advance transactions for a credit cardholder within the past 12 weeks; merchant's average customer age the past 12 weeks; grocery customer's average basket size the past 4 weeks; grocery customer's total spent on the Product Group the past week; grocery customer's mean vector of Product Descriptions embedding the past 2 weeks, etc.

For categorical columns or identifier columns, feature candidate creation facility 304 may utilize unique count aggregations. For categorical columns or any relevant date part (e.g., hour of the day, weekday), feature candidate creation facility 304 may conduct cross-aggregations (bucketing), which generates distributions across different categories of the column. These operations can involve count or sum over the Key Numeric Aggregation Column or any relevant column, typically a column containing values like ‘amount’ and ‘quantity’. Some examples may include, without limitation: grocery customer's total spending across product group the past 4 weeks; merchant's count of invoices across customer age-band the past 12 weeks; and credit cardholder's count of cash advance transactions across weekdays the past 12 weeks.

In some examples, feature candidate creation facility 304 may capture the most recent event in a time window by creating features that capture the latest values for each event view before or after filtering. These operations are performed for entities that are deemed relevant based on the feature engineering plan. For example, such features may include a credit cardholder's latest repayment transaction amount. When the column is an event timestamp, a recency feature is derived by computing the time since the latest timestamp (e.g., time since credit cardholder's latest repayment transaction).

When the use case is event related and geographic data (e.g., latitude and longitude) are present, feature candidate creation facility 304 may calculate distances between the use case event location and the latest location. If data contains a physical presence indicator, this operation is done for physical events only. For example, such features may include distance between current physical transaction location and credit cardholder's latest physical transaction location.

In some embodiments, feature candidate creation facility 304 may derive stability features by, for each entity, comparing features with similar operations using different periods to derive stability features across periods. When the feature is a sum of non-positive or non-negative values, the stability is measured by a ratio normalized by the duration of the periods. For example, such features may include consistency of a credit cardholder's spending, which can be assessed by comparing the total amount spent in purchase transactions over the past 2 weeks to the total spent in the past 12 weeks. If the resulting ratio is greater than 1, it suggests that the cardholder has been spending more than usual in the past 2 weeks.

When the feature is issued from cross-aggregation or the feature is a mean vector, feature candidate creation facility 304 may determine the stability score using any suitable metric of similarity (e.g., cosine similarity). For example, a stability score may indicate the consistency of a credit cardholder's spending behavior on each weekday, which may be assessed by comparing the total amount spent per weekday over the past 2 weeks to the total amount spent per weekday over the past 12 weeks using the cosine similarity metric. In another example, a stability score may indicate the consistency of a grocery customer's product preferences, which may be assessed by calculating the cosine similarity between the mean vector of product description embeddings from the past 2 weeks and the mean vector of product description embeddings from the past 12 weeks.

In one embodiment, feature candidate creation facility 304 may derive similarity features across entities by comparing features with similar operations grouped by different entities or entity groups. When the feature is an average of non-positive or non-negative values, the similarity can be expressed as a ratio. For example, similarity features can include the ratio of a credit cardholder's average repayment amount over the past 52 weeks to the overall population's average repayment amount. In another example, similarity features can include the ratio of a merchant's average customer age over the past 52 weeks to the overall customer age for all purchase transactions in the same state of the merchant.

When the feature is derived from cross-aggregation or the feature is a mean vector, the similarity score can be measured using cosine similarity or any other suitable similarity metric. For example, such features may include the cosine similarity between the customer's grocery basket's expenditure per Product Group and the expenditure patterns in the entire population from the previous 12 weeks. In another example, such features may include the cosine similarity between the mean vector of embeddings that describe the products that a customer has purchased and the expenditure patterns observed in customers of the same age group over the previous 12 weeks.

In some examples, feature candidate creation facility 304 may compare the latest event features with features that involve aggregation of events over windows on a numeric column. Similarity can measured by a Z-Score to determine how the most recent event deviates from historical pattern. For example, such features can include a Z-score for a credit cardholder's most recent purchase amount in comparison to their purchase amount distribution over the past 52 weeks or a Z-score for a customer's most recent basket size in comparison to their basket size distribution over the past 52 weeks.

Additionally or alternatively, feature candidate creation facility 304 may compare features that summarize item data of the latest event for a specific entity to features that aggregate items over windows for the same entity. When the summarization of items involves sum or count, the feature is measured by a ratio. For example, such features may include the ratio of a customer's most recent basket size to the total number of items they have purchased over the past 12 weeks. When summarizing items involves cross-aggregation, creating a mean vector, or similar operations, the similarity score can be determined based on the cosine similarity (e.g., the cosine similarity between the latest customer's grocery basket's expenditure per Product Group and the expenditure patterns in the customer's grocery baskets from the previous 12 weeks, or the cosine similarity between the latest customer's grocery basket mean vector of product description embeddings and the mean vector of product description embeddings from the customer's past 12 weeks of purchases).

In some examples, feature candidate creation facility 304 may convert features that originate from cross-aggregations (bucketing). For example, feature candidate creation facility 304 may derive the entropy if the values in the dictionary are all of the same sign, the key with highest value if the values are non-negative, the key with lowest value if the values are non-positive, and unique count if the values are counts. Some examples may include a customer's most frequent weekday for shopping, the diversity of the latest customer's basket (e.g., determined by counting the unique product groups included in the basket), the diversity of a customer's baskets over the past 12 weeks (e.g., determined by calculating the entropy of the total spending per product group), or the merchant category with the highest total spending for a credit card holder over the past 9 weeks.

Similarly, if the use case has a specific forecast point, feature candidate creation facility 304 may determine its datepart (e.g., hour of the day, weekday), and derive from cross features using the same datepart, past aggregated values for the forecast point datepart. For example, such features may include the customer's spending the same weekday as the forecast point over the past 12 weeks.

If the use case is event related, feature candidate creation facility 304 may compare the attributes of the current event to the same attributes aggregated over various time windows by different entities associated with the use case. If the event attribute is numeric, feature candidate creation facility 304 may compare it to the sum and standard deviation of similar numeric attributes from past events grouped by a specific entity. The resulting feature can be expressed as a Z-Score (e.g., the Z-score of the transaction amount compared to Merchant's past transaction history the past 12 weeks).

When the event attribute is categorical, feature candidate creation facility 304 may calculate a percentage that reflects how often this attribute has appeared historically for a specific entity. This percentage then can be normalized based on the attribute's representation in the entire population, providing a feature that measures of how much this event attribute stands out for that entity. For example, such features may indicate the historical prevalence of the current credit card transaction's merchant category in the cardholder's past transactions the past 12 weeks.

When the event attribute is an embedding, feature candidate creation facility 304 may calculate the cosine similarity with the mean vector of historical embeddings for a specific entity. For example, cosine similarity between a complaint description embedding and past complaint description embeddings over a 4-week period for a customer can be calculated.

If the use case is event related and the event is associated with an item table, feature candidate creation facility 304 may compare the attributes of the current event to similar attributes aggregated over various time windows by different entities associated with the use case. In some examples, feature candidate creation facility 304 may compare features that summarize item data of the event to features that aggregate items over windows for different entities. When summarizing items involves methods such as cross-aggregation or creating a mean vector, the similarity score can be based on the cosine similarity (e.g., the cosine similarity between the invoice basket's expenditure per product group and the expenditure patterns of all invoices from the previous 12 weeks, or the cosine similarity between the mean vector of product description embeddings for the current basket and the mean vector of product description embeddings from the customer's past 12 weeks of purchases).

In some examples, for each Slowly Changing Dimension (SCD) view, feature candidate creation facility 304 may identify changes in attributes. For fields with changing attributes, feature candidate creation facility 304 may determine the time since the latest change in attribute (e.g., time since the latest change in the customer zip code).

If the table contains coordinates, feature candidate creation facility 304 may determine distance with respect to a previous location (e.g., distance between the customer's current location and previous location).

In some examples, in the context of each Slowly Changing Dimension (SCD) view, and for each entity represented within the view as an attribute, feature candidate creation facility 304 may identify the field with a “termination_date” semantic and filter out non-null values. Feature candidate creation facility 304 may count the number of active records for the entity at a specific point in time and perform aggregations or cross aggregations based on the semantics of the attributes. In some examples, feature candidate creation facility 304 may compare those features with features using a prior point in time. For example, such features may include number of active credit cards held by the customer, sum of credit limits of active credit cards held by the customer, or change in number of active credit cards held by the customer vs the number of active credit cards 12 weeks ago.

In some embodiments, feature candidate creation facility 304 may utilize a generative model to identify relevant features generated for the child entities and recommend aggregation operations (e.g., the maximum time since last transaction for active credit cards held by the customer).

### Exemplary Techniques for Automatic Generation of Observation Sets

In some embodiments, as described herein, the declarative framework facility may automatically generate observation set(s) for EDA, training, and/or testing purposes. Observation sets generated via the techniques described herein may avoid data leakage deficiencies based on use of points-in-time that are representative of past inference times associated with use cases.

The declarative framework facility may generate an observation set for a use case based on one or more algorithmic techniques. To automatically generate the observation set(s), a user may provide inputs including a use case name or a context name to identify a respective use case or context; start and end timestamps to define a time period of the observation set; the maximum desired size (e.g., number of rows) of the observation set; and/or a randomization seed.

In some embodiments, the randomization seed is a value used to initialize (e.g., “seed”) a random number generator (RNG), which can then be used to generate a sequence of random points-in-time. In some embodiments, subsequently re-initializing the RNG with the same randomization seed configures the RNG to produce the same sequence of random points-in-time. Thus, the randomization seed facilitates the repeatable production of a sequence of random numbers, which can be particularly useful in scientific experiments, simulations, computer programming, data sampling, and other applications that can benefit from reproducibility. For example, when the values generated by the RNG are used to randomly select entity instances (e.g., rows of a table) for inclusion in an observation dataset, use of a randomization seed renders the sampling step reproducible.

In some embodiments, the feature engineering control platform may prompt the user to provide such inputs. In some cases, for a context view having an entity that is an event entity, a user can optionally select a probability for an entity instance to be randomly selected. A user may select a probability for an instance to be randomly selected to be equal for each entity instance or to be proportional to the duration between the start and end timestamps defining a time period for the observation set. In some cases, for a context view having an entity that is not an event entity, users can optionally provide a desired minimum time interval between a pair of observations of the same entity instance. The desired minimum time interval may not be lower than the inference period (e.g., “target horizon”) and a default value for the desired minimum time interval may be greater than the inference period.

As used herein, “inference period” (or “target horizon”) can refer to the time frame associated with a prediction or forecast. In the context of churn prediction for the next 6 months, the “inference period” refers specifically to that 6-month period. In the context of meteorology, the inference period for forecasting the weather is often the next few days or weeks. In the context of supply chain and inventory management, models may be used to forecast demand for products over various inference periods (e.g., the next month, next quarter, or next year). In some contexts (e.g., the classification of past events, as in fraud detection), the concept of an inference period may not apply (and can be considered as null) because the goal may be to classify an event (e.g., identify a fraudulent transaction) as it occurs or after it has occurred, rather than predicting the occurrence of the event over a future time frame.

In some embodiments, for a use case corresponding to a context view having an entity that is an event entity, the declarative framework facility may automatically generate an observation set based on a number of steps. To generate the observation set, a dataset is initially equal to the context view that is associated with the provided context or use case. From the dataset and above-described inputs, the declarative framework facility may select entity instances (e.g., rows) from the dataset that are subject to materialization (e.g., have timestamps within or durations that intersect the observation period) during the observation period. To select entity instances (e.g., rows) that are subject to materialization during the observation period, the declarative framework facility may (1) remove entity instances (e.g., rows) from the dataset that have a start timestamp that is greater than the input observation end timestamp; and (2) remove entity instances (e.g., rows) from the dataset that have an end timestamp that is less than the input observation start timestamp. Based on selecting entity instances (e.g., rows) that are subject to materialization during the observation period, the declarative framework facility may clip entity instances with start timestamps and end timestamps that are outside the observation period to fit within the edges (e.g., corresponding to the input start and end timestamps) of the observation period. For example, an entity with a duration that begins before the start of the observation time period and ends at a point within the observation time period may be truncated to generate a clipped entity with a start timestamp corresponding to the start time of the observation time period and an end timestamp corresponding to the end timestamp of the original entity. Similar methods may be used to generate clipped entities for entities with start timestamps within the observation time period and end timestamps after the end of the observation time period.

In some embodiments, based on clipping the start timestamps and end timestamps of entity instances that are outside the observation period, the declarative framework facility may randomly generate a point-in-time for each entity instance that is between the start timestamp and end timestamp of the respective entity instance (e.g., row) of the dataset. When a probability for an entity instance (e.g., row) of the dataset to be randomly selected for inclusion in the observation set is selected to be proportional to the duration between the start and end timestamps of the observation period, the declarative framework facility may compute a duration between the start timestamp and end timestamp of the observation period to determine a maximum duration for all entity instances included in the dataset. Based on determining the maximum duration, the declarative framework facility may assign, to each instance of the dataset, a respective probability equal to a duration of the respective instance (e.g., as defined by the instance's start and end timestamps) divided by the determined maximum duration. Based on assigning a respective probability to each instance of the dataset, the declarative framework facility may select entity instances (e.g., rows) from the dataset for inclusion in the observation set based on a Bernoulli distribution and each instance's respective probability. Entity instances of the dataset that are not selected for inclusion in the observation set may be discarded. When a number of selected entity instances for inclusion in the observation set is greater than the input maximum desired size of the observation set, the declarative framework facility may randomly select entity instances from the originally selected entity instances to match the maximum desired size of the observation set, such that the observation set includes a number of entity instances equal to the maximum desired size of the observation set. The generated observation set may be made available by the declarative framework facility for feature historical requests.

When a probability for an instance (e.g., row) of the dataset to be randomly selected for inclusion in the observation set is selected to be equal for each instance, the declarative framework facility may select entity instances (e.g., rows) from the dataset for inclusion in the observation set based on a Bernoulli distribution and each instance's respective probability. The probability may be equal to the maximum desired size (e.g., number of rows) of the observation set divided by the number of instances. Entity instances of the dataset that are not selected for inclusion in the observation set may be discarded. When a number of selected entity instances for inclusion in the observation set is greater than the input maximum desired size of the observation set, the declarative framework facility may randomly select entity instances from the selected entity instances to match the maximum desired size of the observation set, such that the observation set includes a number of entity instances equal to the maximum desired size of the observation set. The generated observation set may be made available by the declarative framework facility for feature historical requests.

In some embodiments, for a use case corresponding to a context view having an entity that is not an event entity, the declarative framework facility may automatically generate an observation set based on a number of steps. To generate the observation set, a dataset may be initially equal to the context view that is associated with the provided context or use case. From the dataset and above-described inputs, the declarative framework facility may modify the desired minimum time interval between 2 observations of the same entity instance. When an inference time for the use case is at any time, the declarative framework facility may modify the minimum time interval to be (1) greater than the original minimum interval; and (2) not a multiple of rounded hours to avoid the same entity instance having multiple points-in-time at the same time of the day and/or week. As an example, a minimum time interval of 7 days may be modified by the declarative framework facility to be 7 days 1 hour and 13 minutes. When an inference time for the use case is at regular interval (e.g., every Monday between 3 to 6) and when the inference time period for the use case is greater the minimum time interval, the declarative framework facility may modify the minimum time interval to be equal to the inference time period. When an inference time for the use case is at regular interval and when the interface period is not greater the minimum time interval, the declarative framework facility may modify the minimum time interval such (1) the modified minimum interval is a multiple of the inference time period; and (2) the modified minimum interval is greater than the original minimum interval.

In some embodiments, based on modifying the minimum interval, the declarative framework facility may select entity instances (e.g., rows) from the dataset that are subject to materialization during the observation period. To select entity instances (e.g., rows) that are subject to materialization during the observation period, the declarative framework facility may (1) remove entity instances (e.g., rows) from the dataset that have a start timestamp that is greater than the input observation end timestamp; (2) remove entity instances (e.g., rows) from the dataset that have an end timestamp that is less than the input observation start timestamp; and (3) remove duplicated entity instances. Based on selecting entity instances (e.g., rows) that are subject to materialization during the observation period, the declarative framework facility may generate a random point-in-time for each instance (e.g., row) included in the dataset. To generate a random point-in-time for each instance (e.g., row) included in the dataset and when the inference time is any time, the declarative framework facility may randomly select the random point-in-time from a period starting at the start timestamp of the observation period and ending at a sum of the start timestamp of the observation period and the minimum time interval. To generate a random point-in-time for each instance (e.g., row) included in the dataset and when the inference time is at a scheduled interval, the declarative framework facility may randomly select the random point-in-time from the inference periods (as defined by the scheduling of the inference) that are within a period starting at the start timestamp of the observation period and ending at a sum of the start timestamp of the observation period and the minimum time interval.

In some embodiments, based on generating a respective random point-in-time for each instance of the dataset, the declarative framework facility may generate an additional instance (e.g., rows) in the dataset by incrementing the original point-in-time with the minimum time interval. The declarative framework facility may repeatedly generate additional entity instances (e.g., rows) in the dataset by incrementing the original point-in-time with a multiple of the minimum time interval until the generated point-in-time is greater than the end timestamp of the observation period. Based on generating one or more additional entity instances in the dataset, the declarative framework facility may remove entity instances from the dataset that have a respective point-in-time greater than the end timestamp of the observation period. Based on removing the entity instances from the dataset, the declarative framework facility may remove entity instances from the dataset for which the entity instance is not subject to materialization at the point-in-time of the context view used to generate the observation set. The declarative framework facility may select the remaining entity instances included in the dataset for inclusion in the generated observation set. When a number of selected entity instances for inclusion in the observation set is greater than the input maximum desired size of the observation set, the declarative framework facility may randomly select entity instances from the selected entity instances to match the maximum desired size of the observation set, such that the observation set includes a number of entity instances equal to the maximum desired size of the observation set. The generated observation set may be made available by the declarative framework facility for feature historical requests.

In some embodiments, the indication of the context identifies an event entity, and the plurality of entity instances is a plurality of event entity instances corresponding to the event entity. In some embodiments, selecting the second subset of entity instances from the first subset of entity instances includes, for each entity instance in the first subset of entity instances, probabilistically adding the entity instance to the second subset of entity instances based on a selection probability associated with the entity instance. In some embodiments, the selection probability associated with the entity instance is based on the one or more timestamps associated with the entity instance. In some embodiments, the one or more timestamps associated with the entity instance include a start timestamp and an end timestamp, and the selection probability associated with the entity instance depends on a difference between the end timestamp and the start timestamp. In some embodiments, the plurality of event entity instances correspond to a plurality of event durations. Each event duration may be equal to a difference between the end timestamp and the start timestamp of the corresponding event entity instance. In some embodiments, method further includes determining a maximum event duration among the plurality of event durations. In some embodiments, the selection probability associated with the entity instance is based on a ratio between the event duration corresponding to the entity distance and the maximum event duration.

In some embodiments, the indication of the context identifies a particular entity other than an event entity, and the plurality of entity instances correspond to the particular entity. In some embodiments, selecting the second subset of entity instances from the first subset of entity instances includes sampling the first subset of entity instances. A minimum sampling interval may be enforced when sampling the first subset of entity instances. In some embodiments, the indication of the context identifies a target object and an inference period associated with the target object. In some embodiments, the method further includes adjusting a value of the minimum sampling interval such that the adjusted value of the minimum sampling interval is greater than the inference period. In some embodiments, the method further includes adjusting a value of the minimum sampling interval such that the adjusted value of the minimum sampling interval is not an integer multiple of one hour.

In some embodiments, selecting the second subset of entity instances from the first subset of entity instances includes, for each entity instance in the first subset of entity instances, (a) randomly selecting a point-in-time from a time period beginning at a start time of the observation time period and having a duration matching the minimum sampling interval; (b) adding the entity instance to the second subset of entity instances if the point in time is less than or equal to an end time of the observation time period and less than or equal to an end timestamp of the entity instance; (c) increasing the point-in-time by the minimum sampling interval; and (d) repeating sub-steps (b)-(d) until the point-in-time is greater than end time of the observation time period or greater than the end timestamp of the entity instance.

### Exemplary Techniques for Automated Feature Job Setting

In some embodiments, as described herein, the feature job orchestration facility may automatically analyze data availability and data freshness (e.g., how recently the data was collected) of source data (e.g., event data) received and stored in the data warehouse. Based on the automatic analysis of the data availability and data freshness of source data, the feature job orchestration facility may determine and provide a recommended setting for feature job scheduling and a blind spot for materializing feature(s) derived from the analyzed source data. Analysis of data availability and data freshness of source data may be based on record creation timestamps added to event data by user(s).

To determine and provide a recommended setting for feature job scheduling and an associated blind spot, the feature job orchestration facility may determine an estimate of a frequency at which the event data is updated in the data warehouse based on a distribution of inter-event time (IET) of a sequence of the record creation timestamps corresponding to the event data. The IET between successive record creation timestamps may indicate a frequency at which the event data is updated in the data warehouse. The feature job scheduling facility may determine and provide a recommendation of the feature job frequency period that is equal to a best estimate of the refresh frequency of the event data's data source. The best estimate of the refresh frequency of the event data's data source may be based on modulo operations between the distribution of the IET and one or more estimated refresh periods. In some situations, these modulo operations may produce a distribution of outputs. In one example, a frequency period estimate may be the division of the true frequency period by an integer. In this example, the results of the modulo operation may either produce two distinct peaks of results with one peak near zero and the other peak near the value for the frequency period estimate. In another example, the frequency estimate may be a multiple of the true frequency period, which can result in a distribution of IET modulo results over two or more areas or peaks, or two peaks that are neither close to zero nor the frequency estimate. In cases where the frequency estimate falls into neither of the aforementioned scenarios, the IET modulo operation result spread may be roughly evenly spread between zero and the estimate.

Searching for the true frequency period can start with an initial guess (e.g., based on the randomization seed) rounded to the nearest appropriate time unit, such as minutes or seconds.

Based on the above-described patterns, the guess can be progressively refined by testing additional candidate values and observing the outputs of the modulo operations. For example, if the distributions of the modulo operations produce an even distribution of values, the search can test smaller candidate values. If the distribution presents according to one of the other patterns, fractions and/or multiples of the initial test value can be tested too. For example, if the distribution of the IET modulo frequency spreads over two extremes, the IET estimate can be translated by t such that the distribution of (IET+t) modulo the frequency period spreads over one area only. The algorithm can then be applied to the new distribution.

Based on the above estimations, the systems and methods described herein can recommend a feature job frequency period based on the best estimate of the data source refresh frequency as determined by the iterative estimation. Multiples of the frequency period can also be suggested if users would prefer to reduce the frequency of feature jobs, e.g., to save on computational resources.

Based on determining the recommendation of the feature job frequency period, the feature job orchestration facility may determine a timeliness of updates to event data from the event data's data source. The feature job orchestration facility may determine one or more late updates to event data from the event data's data source. For the event data including and/or excluding the late updates, the feature orchestration facility may determine a recommended timestamp at and/or before which to aggregate event data used to execute a feature job during a feature job frequency period. A recommended timestamp at which to aggregate event data used to execute a feature job during a frequency period of the feature job may be based on a last estimated timestamp at which event data is updated during the feature job frequency period and a buffer period.

Based on the combination of the last estimated timestamp and the buffer period, the feature job orchestration facility may evaluate one or more blind spots and select one recommended blind spot from the one or more blind spots. Blind spot candidates can be selected to determine cutoffs for feature aggregation windows, thereby allowing the systems and methods described herein to account for data that is not recorded in a data warehouse, database, or other data storage in a timely fashion for processing. For each blind spot, a matrix can be computed that includes tiles of event timestamps as rows, and time that goes up to the largest interval between observed event timestamps and record timestamps as columns. The size of a tile in the matrix can be equal to the feature job frequency period, and tile endpoints can be set as a function of the recommended feature job time and the blind spot candidate.

The matrix values can be equal to the number of events related to the row tile recorded before a timestamp equal to the tile endpoint plus the time defined by the column. Recent event timestamps can be excluded from this calculation to ensure that the matrix is complete. The sum of each column in the matrix provides the average record development of event tiles, and can based on these average records, a percentage of late data can be estimated. Recommended blind spots can provide a percentage of late data that is nearest to a user-defined tolerance, such as 0.005%.

The term “blind spot” as used herein refers to a cutoff window after which data is considered “late” and is not included in estimation calculations. For example, a blind spot of 100 seconds can mean that data landing in the database or data warehouse after 100 seconds from the start of a feature aggregation window will not be included in the aggregation. Candidate blind spots can have an associated “landing” percentage, i.e., a percentage of data landing at the database or data warehouse within a job interval that is included in the aggregation. For example, a set of candidate blind spots can be 70, 80, 90, and 100 seconds, with corresponding “landing rates” of 99.5%, 99.9%, 99.99%, and 100%. The recommended blind spot can be selected based on the landing rates and a user-defined tolerance. In this example, if a user defines a tolerance of 0.01% of events being defined as late, then the recommended blind spot will be 90 seconds. If the user defines a tolerance of 0.1%, then the recommended blind spot will be 80 seconds. Once a blind spot is recommended, users can back test the blind spot on historical data from previous feature job schedules to determine if the blind spot recommendation applies to actual data collected.

In some cases, the blind spot may be described with respect to a start timestamp of the feature job frequency period. The feature job orchestration facility may select the recommended blind spot based on analysis of event timestamps corresponding to event data and the record creation timestamps corresponding to event data. Based on the selected blind spot, the feature job orchestration facility may provide a recommended feature job frequency period, a recommended timestamp at and/or before which to aggregate event data used to execute a feature job during a feature job frequency period, and a blind spot for materializing feature(s) derived from the event data. The recommended feature job scheduling for the feature(s) may be automatically applied for the feature(s) and may be indicated by metadata of the feature(s) as described herein. Feature job scheduling automatically applied for features may be modified.

In some embodiments, data warehouse job failures can result in recommendations of unnecessarily long blind spots. For this reason, the systems and methods described herein can include job-failure detection and provide an analysis both with and without the impact of job failures. Job failure detection can be based on an analysis of the age of records recorded after scheduled jobs for which no new records have been added during their expected update period. If the distribution of the age of the records is similar to the distribution of the age of the records normally observed, the missing jobs can be assumed to be missing due to a lack of data. If the distribution appears anomalous, the missing job can be assumed to be a job failure. Discarding failed jobs from blind spot calculations can ensure that blind spots of an appropriate length are recommended.

### Exemplary Techniques for Automated Annotation of Feature Signal Types

In some embodiments, as described herein, the feature catalog facility may automatically tag each generated feature with a respective theme and included signal type. The feature catalog facility may automatically determine and assign a signal type for each feature based on one or more heuristic techniques. A signal type may be automatically determined and assigned to a feature based on the feature's lineage and the ontology of source data used to materialize the feature. Examples of signal types can include frequency, recency, monetary, diversity, inventory, location, similarity, stability, timing, statistic, and attribute signal types. A feature's lineage may include first computer code (e.g., SDK code) that can be used to declare a version of a feature and second computer code (e.g., SQL code) that can be used to compute a value for the version of the feature from source data stored by the data warehouse.

In some embodiments, the feature catalog facility may perform one or more heuristic techniques to determine a signal type of a feature. To determine whether a feature has a similarity signal type, the feature catalog facility may determine whether the feature is derived from a lookup feature (e.g., lookup feature without aggregation) and time window aggregate features. When the feature is derived from a lookup feature and time window aggregate features, the feature catalog may assign a similarity signal type to the feature. Examples of features with a similarity signal type include (1) a ratio of a current transaction amount to a maximum amount of a customer's transaction over the past 7 days; and (2) a cosine similarity of a current basket to customer baskets over the past 7 days.

In some cases, the feature catalog facility may determine whether a feature is derived from a lookup feature or an aggregation operation that is not a time window aggregate operation. Based on determining a feature is derived from a lookup feature or an aggregation operation that is not a time window aggregate operation, the feature catalog facility may perform one or more determinations. The feature catalog facility may determine whether one input column of the feature has a semantic association with a monetary signal type. When the feature catalog facility determines one input column of the feature has a semantic association with a monetary signal type, the feature catalog facility may assign a monetary signal type to the feature. The feature catalog facility may determine whether one input column of the feature has a semantic association with location. When the feature catalog facility determines one input column of the feature has a semantic association with location, the feature catalog facility may assign a location signal type to the feature.

The feature catalog facility may determine whether the feature is a lookup feature derived from a slowly changing data and includes a time offset. When the feature catalog facility determines the feature is a lookup feature derived from a slowly changing data and includes a time offset, the feature catalog facility may assign a past attribute signal type to the feature. The feature catalog facility may determine whether the feature is a lookup feature with no time offset. When the feature catalog facility determines the feature is a lookup feature with no time offset, the feature catalog facility may assign an attribute signal type to the feature. When feature catalog facility determines a feature is derived from a lookup feature or an aggregation operation that is not time window aggregate operation and the feature is not any of a monetary, location, past attribute, or attribute signal type, the feature catalog facility may assign a default feature such as a statistics signal type to the feature.

In some cases, the feature catalog facility may determine whether a feature is derived from multiple aggregations and multiple windows. When the feature catalog facility determines the feature is derived from multiple aggregations and multiple windows, the feature catalog facility may assign a stability signal type to the feature. The feature catalog facility may determine whether a feature is derived from multiple aggregations using different group keys. When the feature catalog facility determines the feature is derived from multiple aggregations using different group keys, the feature catalog facility may assign a similarity signal type to the feature.

The feature catalog facility may determine whether a feature is derived from an aggregation function using a “last” operation. When the feature catalog facility determines the feature is derived from an aggregation function using a “last” operation, the feature catalog facility may assign a recency signal type to the feature.

The feature catalog facility may determine whether one input column of a feature is an event timestamp. When the feature catalog facility determines one input column of a feature is an event timestamp, the feature catalog facility may assign a timing signal type to the feature. The feature catalog facility may determine whether one input column of the feature has a semantic association with location. When the feature catalog facility determines one input column of the feature has a semantic association with location, the feature catalog facility may assign a location signal type to the feature.

In some embodiments, the feature catalog facility may determine whether the feature is derived from an aggregation per category and an entropy transformation. When the feature catalog facility determines the feature is derived from an aggregation per category and an entropy transformation, the feature catalog facility may assign a diversity signal type to the feature. The feature catalog facility may determine whether the feature is derived from an aggregation per category and an entropy transformation was not used after the aggregation. When the feature catalog facility determines the feature is derived from an aggregation per category and an entropy transformation was not used after the aggregation, the feature catalog facility may assign an inventory signal type to the feature. The feature catalog facility may determine whether one input column of the feature has a semantic association with monetary. When the feature catalog facility determines one input column of the feature has a semantic association with monetary, the feature catalog facility may assign a monetary signal type to the feature.

In some embodiments, the feature catalog facility may determine whether a feature is (or is derived from) a cross-aggregate feature. In general, an aggregate feature may be derived by applying an aggregation operation to a set of data objects related to an entity (e.g., values of a column in a table). Some non-limiting examples of aggregation operations may include the latest operation (which retrieves the most recent value in the column), the count operation (which tallies the number of data values in a column), the NA count operation (which tallies the number of missing data values in the column), and the sum, minimum, maximum, and standard deviation operations (which calculate the sum, minimum value, maximum value, and standard deviation of the values in the column). Likewise, a “cross-aggregate feature” may be derived by aggregating data objects related to an entity across two or more categories. For example, a cross-aggregate feature could be the amount a customer spends in each of K product categories over a certain period. Here, the ‘customer’ is the entity and the ‘product category’ is the categorical variable. Thus, the aggregation is performed across different product categories for each customer. Such a feature reveals spending patterns or preferences, providing insights into customer behavior across diverse product categories. When the feature catalog facility determines the feature is (or is derived from) a cross-aggregate feature, the feature catalog facility may assign a “bucketing” signal type to the feature. Here, “bucketing” refers to aggregating data not just by a single entity, but also two or more categories (buckets) related to the entity.

In some embodiments, the feature catalog facility may determine whether a feature is derived from a time window aggregation and uses a “count” operation. When the feature catalog facility determines the feature is derived from a time window aggregation and uses a “count” operation, the feature catalog facility may assign a frequency signal type to the feature. The feature catalog facility may determine whether a feature is derived from a time window aggregation and uses a “count” operation. When the feature catalog facility determines the feature is derived from a time window aggregation and uses a “standard deviation” operation, the feature catalog facility may assign a diversity signal type to the feature. When the feature catalog facility fails to assign a signal type to a feature based on one of the above described techniques, the feature catalog facility may assign a stats signal type to the feature. In some cases, alternative or additional techniques may be used by the feature catalog facility to automatically determine and assign a feature's signal type.

In some embodiments, the plurality of features is a plurality of first features, and populating the feature catalog further includes generating a plurality of second features based on the plurality of first features. Generating each second feature may include applying one or more data transformations associated with the second feature to one or more of the first features. In some embodiments, generating each second feature includes applying one or more data transformations associated with the second feature to one or more first features and to a respective subset of the source data. In some embodiments, the method further includes, for each second feature, determining one or more signal types of the second feature based at least in part on data indicating signal types of one or more first features used to generate the second feature and the one or more data transformations associated with the second feature; and associating the second feature with the one or more signal types of the second feature in the feature catalog.

### Exemplary Techniques for Automated Feature Discovery

In some embodiments, as described herein, the feature discovery facility of the platform provider control plane may enable users to perform automated feature discovery for features that may be materialized and served by the feature engineering control platform. Semantic labels assigned to data objects (e.g., tables, columns of tables, etc.) by the data annotation and observability facility may indicate the nature of the tables and/or their data fields. The declarative framework facility as described herein may enable users to creatively manipulate tables to generate features and use cases. A feature store facility may enable users to reuse generated features and push new generated features into production for serving (e.g., serving to artificial intelligence models). Based on the functionality of the data annotation and observability facility and declarative framework facility, the feature discovery facility may perform automated feature discovery using a feature discovery algorithm.

In some embodiments, using the feature discovery facility, users may initiate automated feature discovery by the feature discovery facility by providing an input. The input may be (1) a use case or (2) a view and an entity (or a tuple of entities). For a received input use case, the feature discovery facility may first identify the entity relationships of the use case entities. Based on the identified entity relationships of the use case entities, the feature discovery facility may identify all entities associated with the use case (including parent entities and subtype entities of the use case entities) and identify a data model corresponding to the use case that indicates all tables that can be used to generate features for the entities. Based on identifying the entities and the data model, the feature discovery facility may execute, for each entity and each view of the source data included in the data model, the feature discovery algorithm. When the use case is defined by a tuple of entities, the feature discovery facility may execute the feature discovery algorithm for the tuple of entities. For each respective combination of an entity and view (e.g., associated with the use case and/or or received as an input), the feature discovery facility may apply one or more data transformations to the view. The one or more data transformations applied to a view may be selected based on the semantics of data fields included in the view and/or the data type (e.g., event, time-series, item, slowly changing dimension, or dimension) of the view. The one or more data transformations may include joining one or more other views to the view based on the entity. Based on the one or more data transformations applied to the view (or view column), the feature discovery facility may provide one or more feature recipes for display at the graphical user interface that are derived from the view (or view column) and the entity.

### Exemplary Techniques for Generating an Execution Graph

In some embodiments, as described herein, the execution graph facility may enable generation of one or more execution graphs. An execution graph may capture a series of non-ambiguous data manipulation actions to be applied to source data (e.g., tables). An execution graph may be representative of the steps performed to generate a view, column, feature, and/or a group of features from one or more tables. An execution graph may capture and store data manipulation operations that can be applied to the tables, such that the execution graph may be converted to platform-specific instructions (e.g., platform-specific SQL instructions) for feature and/or view materialization when needed (e.g., based on receiving a feature request). An execution graph may include a number of nodes and a number of edges, where edges may connect the nodes and may represent input and output relationships between the nodes. A node may indicate a particular operation (e.g., data manipulation and/or transformation) applied to input data (e.g., input source data or transformed source data). An edge connected between a first node and a second node may indicate that an output from a first node is provided as an input to a second node. Source data and/or transformed source data may be provided as an input to an execution graph. A view or feature may be an output of an execution graph.

In some embodiments, an execution graph may be generated from intended data transformation operations by a data manipulation API. The data manipulation API may be implemented in a computer programming language such as Python. Implementation of the data manipulation API in Python may enable codification of data manipulation steps such as column transformations, row filtering, projections, joins, and aggregations without the use of graph primitives.

In some embodiments, an execution graph may include metadata to support extensive validation of generated features and/or views and to infer output metadata for the generated features and/or views. Metadata included in an execution graph can include data metadata. Data metadata can include a data type for input source data provided as an input to the execution graph used to generate the feature(s) and/or view(s) and an indication of the column(s) from the input source data. Metadata included in an execution graph can include column metadata. Column metadata can include a data type, entity, data semantic, and/or cleaning steps for a column and/or columns corresponding to the column metadata. Metadata included in an execution graph can include node metadata. Node metadata can include arbitrary tagging applied to a node, which may be indicative of an operation corresponding to the node such as “cleaning”, “transformation”, or “feature.” Metadata included in an execution graph can include subgraph metadata. Subgraph metadata may include arbitrary tagging applied to a subgraph included in the execution graph.

In some embodiments, as described herein, a value of a feature may be dependent on an additional input (e.g., an observation set) that may be unavailable prior to the time of materialization of the feature. A feature may be partially computed and cached as tiles (e.g., as described with respect to the feature store facility). An execution graph may support creation of SQL for computing one or more of: feature values without using tiles, feature values using tiles, and tile values.

In some embodiments, each node included in an execution graph may represent an operation on an input to the respective node. A node's edges may represent input and output relationships between nodes. A subgraph of an execution graph may include a starting node and may include all nodes connected to the starting node from the input edges of the starting node. A proper subgraph of an execution graph may be a subgraph that represents each of the steps performed to generate a view or a group of features from input data provided to the subgraph. In some cases, a subgraph can be pruned to reduce the complexity of the subgraph without changing the output of the subgraph. Some examples of pruning steps that can be applied to a subgraph of an execution graph can include excluding unnecessary columns in projections, removing redundant nodes, removing redundant parameters in nodes. Pruning may simplify an execution graph's representation of operations and reduce computation and storage costs for the execution graph.

In some embodiments, the execution graph facility may support nesting of subgraphs, where a subgraph of an execution graph can be included as a node in another execution graph. Nesting can facilitate the representation of a group of operations as a single operation to facilitate reuse of the group of operations and improve readability of an execution graph. Examples of such operations can include data cleaning steps and multi-step transformations.

### Computer-Based Implementations

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media of a computer system 500) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 5, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 5 is a block diagram of an example computer system 500 that may be used in implementing the technology described in this document. General-purpose computers, network appliances, mobile devices, or other electronic systems may also include at least portions of the system 500. The system 500 includes components, including a processor 510, a memory 520, a storage device 530, and an input/output device 540. Each of these components may be interconnected, for example, using a system bus 550. The processor 510 is capable of processing instructions for execution within the system 500. In some implementations, the processor 510 is a single-threaded processor. In some implementations, the processor 510 is a multi-threaded processor. In some implementations, the processor 510 is a programmable (or reprogrammable) general purpose microprocessor or microcontroller. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more network interface devices, e.g., an Ethernet card, a serial communication device, e.g., an RS-232 port, and/or a wireless interface device, e.g., an 802.11 card, or a 3G, 4G, or 5G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array), an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a facility, a software facility, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method comprising:
obtaining a description of a use case for a machine learning model and metadata relating to a set of source data for the machine learning model;
producing, using a feature engineering model, one or more views of the set of source data for the machine learning model based at least in part on the description of the use case and the metadata;
creating a plurality of candidate features based at least in part on the one or more views;
assessing relevance of the plurality of candidate features to the use case, wherein assessing the relevance of the plurality of candidate features includes assessing, by a semantic relevance model, semantic relevance of the plurality of candidate features to the use case; and
adding one or more features selected from the plurality of candidate features to a feature set for the use case for the machine learning model based on the relevance of the one or more candidate features to the use case as assessed by the semantic relevance model.

2. The method of claim 1, wherein producing the one or more views comprises generating, by a feature description model, metadata for the one or more features added to the feature set.

3. The method of claim 2, wherein the metadata comprises:
respective names of the one or more features added to the feature set; and/or
respective descriptions of the one or more features added to the feature set.

4. The method of claim 1, wherein producing the one or more views comprises generating, by a semantic discovery model, a plurality of tags for a plurality of fields of the set of source data.

5. The method of claim 1, wherein producing the one or more views comprises sending instructions to a server that hosts the set of source data to produce the one or more views.

6. The method of claim 1, wherein producing the one or more views comprises performing one or more transformations on one or more tables within the set of source data based at least in part on assessing a semantic relevance of data within the one or more tables.

7. The method of claim 1, wherein the set of source data includes a plurality of tables, and wherein producing the one or more views comprises developing, by the feature engineering model, a feature engineering plan, including:
identifying one or more fields of the set of source data relevant to the use case and one or more entities relevant to the use case; and
identifying one or more candidate table join operations performable on one or more of the tables associated with the one or more entities.

8. The method of claim 7, wherein the one or more tables include one or more event tables and/or item tables, and wherein developing the feature engineering plan further comprises devising one or more filtering strategies for the one or more event tables and/or item tables.

9. The method of claim 7, wherein developing the feature engineering plan further comprises suggesting at least one transformation applicable to the set of source data to generate at least one new field of the set of source data.

10. The method of claim 7, further comprising implementing the feature engineering plan.

11. The method of claim 10, wherein implementing the feature engineering plan comprises performing the one or more candidate table join operations, filtering one or more event tables and/or item tables of the set of source data, and/or applying one or more suggested transformations to the set of source data.

12. The method of claim 10, wherein implementing the feature engineering plan comprises outputting instructions executable by one or more processors to perform the one or more candidate table join operations, filter one or more event tables and/or item tables of the set of source data, and/or apply one or more suggested transformations to the set of source data.

13. The method of claim 1, wherein assessing, by the semantic relevance model, the semantic relevance of the plurality of candidate features comprises generating, for each candidate feature in the plurality of candidate features, a semantic relevance score based on one or more attributes of the candidate feature and one or more attributes of the use case.

14. The method of claim 13, wherein the one or more attributes of the candidate feature include a description of the candidate feature, metadata corresponding to one or more tables from which the candidate feature is derived, metadata corresponding to one or more columns of one or more views from which the candidate feature is derived, and/or one or more filters applied to data from which the candidate feature is derived.

15. The method of claim 13, wherein the one or more attributes of the use case include the description of the use case.

16. The method of claim 1, wherein assessing the relevance of the plurality of candidate features to the use case further includes determining, for each candidate feature in the plurality of a candidate features, a statistical relevance score indicating a statistical relevance of the feature to a target of the use case, including:
materializing the candidate feature with an observation set for the candidate feature based on the description of the use case; and
producing, by a statistical relevance model, the statistical relevance score for the materialized candidate feature, wherein the statistical relevance score measures a relationship between the materialized candidate feature and the target within a context of the use case.

17. The method of claim 1, wherein adding the one or more features to the feature set comprises:
selecting, by a feature selection model, the one or more features from the plurality of candidate features based on the relevance of the one or more candidate features to the use case; and
adding one or more feature recipes to the feature set, wherein the one or more feature recipes indicate how the one or more features are derived from the set of source data.

18. The method of claim 1, wherein adding the one or more features selected from the plurality of candidate features to the feature set comprises:
presenting the plurality of candidate features to a user for selection; and
adding the one or more features to the feature set in response to the user selecting the one or more features.

19. An apparatus comprising:
at least one processor; and
at least one computer-readable storage medium having encoded thereon executable instructions that, when executed by the at least one processor, cause the at least one processor to perform operations including:
obtaining a description of a use case for a machine learning model and metadata relating to a set of source data for the machine learning model;
producing, using a feature engineering model, one or more views of the set of source data for the machine learning model based at least in part on the description of the use case and the metadata;
creating a plurality of candidate features based at least in part on the one or more views;
assessing relevance of the plurality of candidate features to the use case, wherein assessing the relevance of the plurality of candidate features includes assessing, by a semantic relevance model, semantic relevance of the plurality of candidate features to the use case; and
adding one or more features selected from the plurality of candidate features to a feature set for the use case for the machine learning model based on the relevance of the one or more candidate features to the use case as assessed by the semantic relevance model.

20. A non-transitory computer-readable medium comprising one or more computer-readable instructions that, when executed by at least one processor of a computing device, cause the computing device to:
obtain a description of a use case for a machine learning model and metadata relating to a set of source data for the machine learning model;
produce, using a feature engineering model, one or more views of the set of source data for the machine learning model based at least in part on the description of the use case and the metadata;
create a plurality of candidate features based at least in part on the one or more views;
assess relevance of the plurality of candidate features to the use case, wherein assessing the relevance of the plurality of candidate features includes assessing, by a semantic relevance model, semantic relevance of the plurality of candidate features to the use case; and
add one or more features selected from the plurality of candidate features to a feature set for the use case for the machine learning model based on the relevance of the one or more candidate features to the use case as assessed by the semantic relevance model.
